(19) United States
(12) Patent Application Publication
(10) Pub. No.: US 2011/0039078 A1
(43) Pub. Date: Feb. 17, 2011

(54) INK COMPRISING NANOSTRUCTURES

(76) Inventors: Margaret Elizabeth Brennan Fournet, County Galway (IE); Patrick Fournet, County Galway (IE); Deirdre Marie Ledwith, County Offaly (IE)

Correspondence Address: JACOBSON HOLMAN PLLC, 400 SEVENTH STREET N.W., SUITE 600, WASHINGTON, DC, 20004, US

(21) Appl. No.: 12/736,622

(22) PCT Filed: Apr. 8, 2009
(86) PCT No.: PCT/IE2009/000016

§ 371 Date: Oct. 22, 2010

Related U.S. Application Data
(60) Provisional application No. 61/071,392, filed on Apr. 25, 2008.
(60) Provisional application No. 61/136,809, filed on Oct. 6, 2008.

(30) Foreign Application Priority Data
Apr. 25, 2008 (IE) 2008/0326

(51) Int. Cl. C09D 11/00; B32B 3/10

(52) U.S. Cl. 428/195.1; 106/31.13

(57) ABSTRACT

An ink comprising a solution or suspension or mixture of silver nanoplates in a liquid wherein said nanoplates have a distribution of geometric shapes within which one shape geometries selected from the following is predominant: circular plate shaped; elliptical plate shaped; triangular plate shaped; hexagonal plate shaped; other flat polygonal plate shaped.

### INTRODUCTION

This invention relates to an ink comprising nanostructures. In particular, the invention relates to an ink comprising silver nanoplates.

Existing inks which incorporate metallic nanopstructures suffer from one or more of the following disadvantages: the ink is not aqueous-based; the nanoparticles aggregate in the ink; the nanoparticle size is not well controlled; the formation of agglomerates of nanoparticles lead to dispersion and miscibility difficulties serving to diminish optical and electrical properties; the nanoparticles shape is not controlled. Among the consequences of this are an inability to control the electrical and optical properties of the ink, and the excessive loading of the ink with metal nanoparticles in order to assure a conductive path on deposition of the ink. The former problem limits the applications of the ink, and the latter problem is a cost issue, especially where the metal in the ink is selected from the precious metals. Moreover, there is also a practical requirement to be able to produce the ink in large volumes for it to be industrially applicable in practice.

### STATEMENTS OF INVENTION

The invention provides an ink comprising a solution or suspension or mixture of silver nanoplates in a liquid wherein said nanoplates have a distribution of geometric shapes within which one shape geometrics selected from the following is predominant:
circular plate shaped;
elliptical plate shaped;
triangular plate shaped;
hexagonal plate shaped;
other flat polygonal plate shaped.

The predominant shape geometry may be triangular plate shaped.

The nanoplate may have an aspect ratio between 2 to 25.

The liquid may be an aqueous solution, such as water. Alternatively, the liquid may be an organic solvent. The organic solvent may be an alcohol such as ethanol or methanol, or the organic solvent may be dimethylformamide. The liquid may be capable of being readily evaporated from a substrate on which the ink is deposited.

The ink may comprise a viscosity lowering agent. The viscosity lowering agent may be a polymer such as polyvinyl alcohol or polyvinyl pyrrolidone. The ink may comprise up to 20% wt of the viscosity lowering agent, such as up to 10% wt of the viscosity lowering agent, for example about 5% wt of the viscosity lowering agent.

The ink may comprise a surface tension lowering agent. The surface tension lowering agent may be diethylene glycol. The ink may comprise up to 50% wt of the surface tension lowering agent.

The nanoplates may be surface functionalised. The nanoplates may be surface functionalised with a chemical and/or a biological functionalising agent. The functionalising agent may be selected from one or more of: cytidine 5′-diphasphocholine, mercapto-hexanoic acid, and mecapto-benzoic acid.

The ink may comprise a stabilising agent, such as trisodium citrate.

The ink may have an average resistivity value of up to 2.5×10⁻⁴ Ωcm.

The ink may comprise up to 1.5% wt silver. The ink may comprise up to 30% wt silver. The ink may comprise up to 70% wt silver.

The invention further provides a substrate having an ink as described herein delivered or deposited thereon. Part or all of the liquid may be removed after delivery of the ink onto the substrate. A conductive path may be formed after the delivery of the ink onto the substrate. At least some of the nanoplates and the liquid may form the conductive path. Alternatively, some of the nanoplates may form the conductive path by making contact with each other.

The invention also provides wires or conductive lines, or tracks made using an ink as described herein.

The invention also provides for the use of an ink as described herein in the fabrication of electrical circuits; in the fabrication of photovoltaic cells for solar power or fuel cell applications; in the manufacture of an optical filter. The optical filter may have preferential absorption at certain wavelengths. The wavelengths of preferential absorption may be altered by altering the concentration of nanoplates in the ink. The wavelengths of preferential absorption may be altered by altering the distribution of sizes of nanoplates in the ink. The wavelengths of preferential absorption may be altered by altering the distribution of shapes of nanoplates in the ink.

The ink may be used to modify the absorption of radiation, especially of solar radiation, by a photovoltaic cell; to modify the photocurrent generated by a photovoltaic cell under conditions of radiation intensity on the cell; or to induce or enhance a plasmonic response.

We also describe a process for synthesising silver nanoparticles comprising the steps of:
(a) forming silver seeds from a silver source and a reducing agent; and
(b) growing the thus formed silver seeds into silver nanoparticles
   wherein step (a) or (b) is performed using microfluidic flow chemistry.

Silver nanoparticles produced by the process may have an average diameter of between 5 nm and 200 nm such as between 5 nm and 100 nm and a UV-vis spectrum peak in the 420 nm to 1100 nm region, such as in the 420 nm to 900 nm region.

Both steps (a) and (b) may be performed using microfluidic flow chemistry.

The silver source may be a silver salt, for example silver nitrate. The silver source may be dissolved in a capping agent solution, for example a capping agent solution selected from the group consisting: Trisodium Citrate, Cetyl-trimethyl-ammonium-bromide.

The reducing agent may be selected from the group consisting: sodium borohydride, ascorbic acid.

The ratio of silver source:reducing agent may be about 1:8.

Step (a) may be performed using microfluidic flow chemistry with a flow rate of between 3 ml/min and 10 ml/min for the silver source. Step (a) may be performed using microfluidic flow chemistry with a flow rate of about 1 ml/min for the reducing agent. Step (a) may be performed at 0° C.

Step (b) may further comprise the step of aging the silver seeds. The aging step may comprise:
mixing a silver source with a polymeric stabiliser; and
mixing the thus formed silver source-polymeric stabiliser component with silver seeds produced by step (a).

The silver source of the aging step may be the same as the silver source used in step (a).

The polymeric stabiliser may be water soluble. The polymeric stabiliser may have a molecular weight between 10 kDa and 1300 kDa. The polymeric stabiliser may be selected from one or more of the group consisting: poly(vinyl alcohol), poly(vinyl pyrollidone), poly(ethylene glycol), and poly(acrylic acid). For example, the polymeric stabiliser may be poly(vinyl alcohol).

The aging step may further comprise the step of reducing the silver source present in the silver source-polymeric stabiliser-silver seed mixture. The silver source may be reduced by ascorbic acid.

Step (b) of the process may be carried out at a temperature of between 10° C. to 60° C. For example, step (b) may be carried out at a temperature of 40° C.

The nanoparticles produced by the process may be stable in an aqueous solution. The nanoparticles produced by the process may have a colour tunability throughout the visible and near infra red spectrum. The nanoparticles produced by the process may be red in colour in a colloidal aqueous solution. The nanoparticles produced by the process may comprise at least 30% non-spherical shaped nanoparticles. The nanoparticles produced by the process may comprise at least 50% non-spherical shaped nanoparticles. For example, at least 70% non-spherical shaped nanoparticles. The non-spherical shaped nanoparticles may be triangular and/or hexagonal and/or truncated triangular in shape. The nanoparticles produced by the process may have a UV-vis spectral peak in the 345 nm region. The nanoparticles produced by the process may have a UV-vis main spectral width FWHM of less than 300 nm. For example, a UV-vis main spectral width FWHM of less than 150 nm, such as a UV-vis main spectral width FWHM of less than 120 nm or a UV-vis main spectral width FWHM of less than 100 nm.

Microfluidic processes described herein can produce, large volumes of high definition silver nanoparticles with improved properties over the conventional wet chemistry methods including, narrower size distribution, increased presence of shaped nanoparticles, higher uniformity of samples, better and high batch to batch reproducibility.

Silver nanoparticles produced in accordance with the processes described herein may possess one or more of the following characteristics:
Approximately 30 nm in diameter
Narrow distribution of size about the 30 nm median
Presence of shaped nanoparticles e.g. triangles
Red in colour when in aqueous solution
UV-Vis Spectrum with main peak in the 420-1100 nm region, such as in the 42-950 nm region
FWHM of main UV-Vis spectral peak to be 150 nm or less
Stable in aqueous solution

Improvements in the production of silver nanoparticles using the microfluidics technology described herein include:
High percentage of triangles vs spheres
UV-Vis main spectral peak FWHM of less than 100 nm

Properties of high definition silver nanoparticles include:
Size of 200 nm or less such as 130 nm or less
Narrow size distribution
Presence of shaped non spherical nanoparticles
Non aggregated

Properties of high definition silver nanoparticles which can be observed in the UV-Vis absorption include:
Spectral peak in the 345 nm region—this is a key characteristic of the presence of shaped non-spherical silver nanoparticles
Peak or peaks beyond 420 nm
Spectral width of less than 300 nm or ideally 150 nm at FWHM

Microfluidics can be used to produce these shaped silver nanoparticles with the important advantage that microfluidics produced a half litre per batch (and is capable of producing several litres per hour) while the wet chemistry method is limited to 100 ml production. TEM images confirmed a significant improvement in the size distribution of the microfluidic processor produced silver nanoparticles. Optimisation of the microfluidic processes both the chip and the processor routes will enable the controlled scaled-up production of high quality high definition silver nanoparticles in a range of shapes, sizes, colours, surface chemistries. This technology can be adapted for the scaled up production of a range of high quality nanoparticles.

Also described is an ink comprising a solution or suspension of nanoparticles in a liquid wherein said nanoparticles have a distribution of geometric shapes within which two or more shape geometries selected from the following are predominant:
a. spherical;
b. ellipsoidal;
c. circular plate shaped;
d. elliptical plate shaped;
e. tetragonal;
f. triangular;
g. hexagonal;
h. tetragonal plate;
i. triangular plate;
j. hexagonal plate;
k. cubic;
l. other flat polygonal;
m. other three-dimensional volume shape.

Further, we describe an ink comprising a solution or suspension or mixture of nanoparticles in a liquid wherein said nanoparticles have a distribution of geometric shapes within which one shape geometry selected from the following is predominant:
a. spherical
b. ellipsoidal
c. circular disk shaped
d. elliptical disk shaped
e. tetragonal plate
f. triangular plate
g. hexagonal plate
h. tetragonal
i. triangular
j. hexagonal
k. cubic
l. other flat polygonal
m. other three-dimensional volume shape.

The liquid may be water or an aqueous solution of other materials in water. Alternatively the liquid may be an organic solvent. The liquid may be capable of being readily evaporated from a substrate on which the ink is deposited.

The nanoparticles may have a preferential distribution of volumes or characteristic length dimensions within a narrow range about a mean volume or mean characteristic length dimension. The nanoparticles may be electrically conducting nanoparticles. The nanoparticles may be metal nanoparticles. The metal may be silver.

The liquid may be electrically conducting. In this case at least some of the nanoparticles and the liquid may form a conductive path by making contact with each other and/or with the liquid.

In one case at least some of the nanoparticles form a conductive path by making contact with each other. Preferably the number of nanoparticles per unit volume exceeds the percolation threshold for a specific volume or area geometry into which the ink is to be deposited, such that there exists a high probability (at least greater than 0.99) of said conductive path being formed by contact of some of the conducting particles when the ink is deposited in that particular volume or area geometry.

We also describe a substrate having an ink described herein delivered or deposited thereon. Part or all of the liquid may be removed after delivery of the ink onto the substrate. The morphology of the distribution of the nanoparticles may be changed during or after the delivery of the ink onto the substrate.

In one case a conductive path is formed after the delivery of the ink onto the substrate. At least some of the nanoparticles and the liquid may form the conductive path. Alternatively some of the nanoparticles form the conductive path by making contact with each other. In this case the predominant nanoparticle shape is chosen such that the amount of metal per unit volume may be reduced to a minimum while the probability of the existence of a conductive path remains sufficiently close to unity for the reliable industrial application of the ink in applications where a conductive path is required.

In one case, as a result of reducing the amount of nanoparticles, and/or changing their predominant size or shape, there is a low probability of forming a conductive path in applications where conduction is undesirable.

Wires or conductive lines, or tracks may be made using an ink described herein.

The ink may be used in the fabrication of electrical circuits such as in the manufacture of electrical circuits on a board by means of depositing one or more layers of non-conducting material and at least one conducting layer comprised of the said ink. The ink may be used in the fabrication of photovoltaic cells for solar power or fuel cell applications.

The ink may be used in the manufacture of an optical filter. Said optical filter may have preferential absorption at certain wavelengths. The wavelengths of said preferential absorption of said optical filter may be altered by means of altering the concentration of nanoparticles in the ink. The wavelengths of said preferential absorption of said optical filter may be altered by means of altering the distribution of sizes of nanoparticles in the ink. The wavelengths of said preferential absorption of said optical filter may be altered by means of altering the distribution of shapes of nanoparticles in the ink.

The ink may be used to modify the absorption of radiation, especially of solar radiation, by a photovoltaic cell. In one case the ink may be used to modify the photocurrent generated by a photovoltaic cell under conditions of radiation intensity on the cell. The ink may be used to induce or enhance a plasmonic response.

### BRIEF DESCRIPTION OF THE DRAWINGS

The invention will be more clearly understood from the following description of an embodiment thereof, given by way of example only, with reference to the accompanying drawings, in which:—

FIG. 1 is an example of a microfluidic flow chemistry synthesis for the first step (silver seed synthesis) of the process for the production of discrete high definition silver nanoparticles;

FIG. 2 is an example of a microfluidic flow chemistry synthesis for the second step (silver seed growth into silver nanoparticles) of the process for the production of discrete high definition silver nanoparticles;

FIG. 3(A) is a schematic of a microfluidic system using a generic microfluidics chip for silver seed production; (B) is a detailed schematic of the generic microfluidics chip for silver seed production;

FIG. 4 is an example of implementation of protocol for silver seed production using a microfluidic chip system;

FIG. 5 is a schematic showing a microfluidic chip set up showing reagent input sequencing for general nanoparticle production;

FIG. 6 is a schematic of a microfluidics chip set up showing reagent output sequencing specifically designed for discrete high definition silver nanoparticle synthesis;

FIG. 7 illustrates information on microfluidics chip design requirements showing stream input and mixing criteria;

FIG. 8 shows discrete silver nanoparticles produced using seeds synthesized using a generic microfluidic chip system with a flow rate ratio of 8:1 for solution 1 and 2. Conventional wet chemistry was used to grow the seeds to form the nanoparticles; (A) is a UV-visible spectrum; (B) is a TEM micrograph; (C) is a plot showing the size distribution of the nanoparticles; and (D) is a plot showing the distribution of hexagons and triangles/truncated triangles;

FIG. 9 shows discrete silver nanoparticles produced using seeds synthesized using a generic microfluidic chip system with a flow rate ratio of 8:1 for solution 1 and 2. Conventional wet chemistry was used to grow the seeds to form the nanoparticles; (A) is a UV-visible spectrum; (B) is a TEM micrograph; (C) is a plot showing the size distribution of the nanoparticles; and (D) is a plot showing the distribution of hexagons and triangles/truncated triangles;

FIG. 10 is a UV-Visible spectrum of silver seeds produced with a flow rate ratio of 8:1 of solution 1 and 2 respectively;

FIG. 11 shows the dependence of seed parameters with variation of flow rate solution 1 (AgNO₃ and TSC) from 3 to 10 ml/min while keeping flow rate of solution 2 constant at 1 ml/min; (A) is a plot showing FWHM dependence; and (B) is a plot showing the dependence of the maximum wavelength;

FIG. 12 (A) is a graph showing the UV-visible spectrum for nanoparticles; and (B) is a TEM micrograph of the nanoparticles, the discrete silver nanoparticles were produced from seeds synthesised by conventional wet chemistry (step (a)) and the seeds were grown into nanoparticles using a microfluidics processor (step (b));

FIG. 13(A) is a UV-Visible spectra for silver seeds synthesised in presence of PSSS using a microfluidics processor method (seeds); discrete silver nanoparticles prepared by a conventional wet chemistry growth in presence of PSSS (step (b)) of microfluidics synthesised silver seeds (step (a)) (beaker experiment); and discrete silver nanoparticles produced from microfluidics synthesised silver seeds (step (a)) and microfluidics grown nanoparticles (step (b)) (microfluidics reaction technology); (B) is a UV-Visible spectra of a silver seed solution synthesised using a conventional wet chemistry method (seeds); discrete silver nanoparticles prepared using a conventional wet chemistry method for both steps (a) and (b) (beaker experiment); and discrete silver nanoparticles prepared using a microfluidics process and the conventionally prepared seeds (step (b)) (microfluidic reaction technology);

FIG. 14 is a UV-Visible spectra for a range batches of discrete silver nanoparticles prepared under the same conditions by conventional wet chemistry method for both steps 1 and 2 (each line represents a different batch);

FIG. 15 (A), (B) and (C) are TEM images for a range of discrete silver nanoparticles prepared under the same conditions by conventional wet chemistry method for both steps 1 and 2;

FIG. 16 is a UV-Visible spectra for a range of batches of silver seeds (Step 1) prepared under the same conditions by conventional wet chemistry method (each line represents a different batch);

FIG. 17 are transmission electron microscope (TEM) images of silver nanoparticles used in an embodiment in the invention;

FIG. 18 is a histogram of silver nanoparticle diameter distribution in the ink after removal of the polymer in accordance with an embodiment of the invention;

FIG. 19: (A) and (B) are TEM images of nanoparticles self assembling to form linear paths in accordance with an embodiment of the invention;

FIG. 20 are TEM images showing the formation of a conductive track structure from the ink by two processes in accordance with an embodiment of the invention: (A) by the merging of nanoparticles and (B) by the assembly of nanoparticles;

FIG. 21 (A) to (C) are TEM images showing the formation of dendrites and fractals using an ink in accordance with an embodiment of the invention;

FIG. 22 is a graph of the viscosity of PVA-based Nanosilver inks as a function of PVA concentration;

FIG. 23 is an illustration of a silver nanoparticle thin film with thickness measurement using razor blade techniques;

FIG. 24 (A) is a UV visible spectrum and (B) is a TEM micrograph of ink incorporating silver nanoplates with one predominant shape in aqueous solution;

FIG. 25: (A) is a UV visible spectrum and (B) is a TEM micrograph of ink incorporating silver nanoparticles with two dominant shapes in aqueous solution made by a batch wet chemistry method;

FIG. 26: (A) is a UV visible spectrum, (B) is a TEM micrograph of ink incorporating silver nanoplates made using a microfluidic process for synthesising the seeds and a batch wet chemistry method for growing the seeds, (C) is the distribution of two dominant shapes in aqueous solution, (D) is an AFM measurement of the height of such a nanoparticle;

FIG. 27 is a UV visible spectrum of silver nanoplates with two dominant shapes in a range of organic solvents;

FIG. 28 is a TEM image of a sample of concentrated silver nanoplate ink;

FIG. 29 (A) and (B) are TEM micrographs of triangular shaped and hexagonal shaped nanoplates respectively;

FIG. 30 (A) is an image of ink-jet printed silver nanoplate ink line before annealing; and (B) is an image of ink-jet printed silver nanoplate ink line after annealing at 200° C. for 6 min;

FIG. 31 are AFM images showing a A) 10×10 μm² and B) 3×3 μm² top view of the silver nanoplate ink printed line of FIG. 30;

FIG. 32: A) is an AFM image and B) is an analysis of a cross section of the silver nanoplate ink printed line of FIG. 30 showing a 96 nm line thickness;

FIG. 33 are schematic illustrations of conductive paths in nanoparticles illustrates that (A) spherical particles have only single point contact whereas shaped nanoparticles (nanoplates) such as hexagons (B), triangles (C) a shaped mixtures (D) provide increased conductive pathways;

FIG. 34 is a metallurgical microscope image of the printed silver nanoplate ink on a DK test chip with gold metallisation and silicon nitride passivation. The arrows indicate the clearly visible two probe marks which were used for the ink electrical characterisation;

FIG. 35 is a UV visible spectra demonstrating that the surface plasmonics/light trapping/wave guiding properties of the inks described herein can be tuned across the relevant sun spectral range;

FIG. 36 A to C are schematics of: photovoltaic devices incorporating nanoplates as (A) an active material; (B) a semi-transparent top electrode; and (C) a bottom electrode; and

FIG. 37 is a UV-visible absorption spectra and images of optical filter thin films deposited on glass substrates using shaped silver nanoplate ink solutions of various colours.

### DETAILED DESCRIPTION

We describe an ink comprising nanoplates. Nanoplates are a subset of nanoparticles having lateral dimensions (such as edge length) that are larger than their height (thickness). The term nanoplate includes for example nanodisks and nanoprisms. Nanoprisms have an equilateral triangular shape.

The nanoplates are high definition silver nanoplates and are synthesized or produced using a two step process: First silver seed solution is produced (step (a)) from a silver source and in a second step (step (b)) these silver seeds are used to grow the silver nanoplates in the presence of a silver source. The silver source may be a silver salt or a complexed silver compound or salt.

The nanoplates may be synthesized using batch wet chemistry, microfluidic processing shear mixing, or a combination of these methods.

### Batch Wet Chemistry

Nanoparticles can be prepared according to the seed mediated methods described in PCT/IE2008/000097, the entire contents of which is incorporated herein by reference.

### Microfluidic Processing

Microfluidics technologies for the production of the discrete high definition silver nanoparticles can be applied to the silver seed production step (step (a)), or the growth of the seed to step (step (b)), or to both steps.

Microfluidic methods for the production of discrete high definition silver nanoparticles allows for silver nanoparticles to be produced in a predetermined and controlled manner. The silver nanoparticles formed are highly shaped, e.g. contain a high percentage of triangles and hexagons compared to spheres, and have a narrow size distribution in a desired size range such as 25 nm or 30 nm or 40 nm or larger or smaller. Such nanoparticles will have a UV-visible spectrum with a main peak at wavelengths longer that 420 nm and the FHWM of this peak will be less than 100 nm.

Employing a combination of both the microfluidic chip and microfluidics processor methods for step (a) and step (b) enables scaled-up production of discrete high definition silver nanoparticles with high batch to batch reproducibility and improved nanoparticle properties including narrower size distribution, increased presence of shaped nanoparticles and a higher uniformity of the silver nanoparticles. The microfluidic methods provide a control over the size, shape, spectral profile and surface chemistries of discrete high definition silver nanoparticles. This technology can be adapted for the scaled up production of a range of both metallic and non metallic high quality nanoparticles.

It will be appreciated that scaled up production requires larger volumes of reagents and for the synthesis process to be successful, the reagents have to be thoroughly mixed. We have surprisingly found that nanoparticles having a controlled shape and size can be produced by mixing the reagents in small volumes such as between about 10 picoliters (pl) to about 100 μl. Microfluidic methods are ideal for the thorough and rapid mixing of reagents in such small volumes.

Mixing of the reagents may be performed in small volumes in a microfluidic reactor at high or differential flow rates. For example at flow rates between about 1 ml/min to about 10 ml/min for low pressure systems and flow rates of at least 10 ml/min up to litres/min for high pressure systems. The reagents used in step (a) and/or step (b) of the process may have differential flow rates. The flow rate of individual reagents can be variably controlled within a microfluidic reaction system resulting in the reagent solutions being rapidly and thoroughly mixed.

We have also found that the ratio of the reagents, and/or the ratio at which the reagents are mixed can impact the physical properties of the nanoparticles formed. For example, an excess of about eight times the reducing agent solution to the silver salt solution has been found to be optimum for the reaction chemistry for producing silver seeds in step (a) of the process.

The performance of certain aspects of the reaction chemistry, for example in step (b) of the process may require a microfluidic reactor which is capable of delivering reagent solutions under high pressures for example between about 35 MPa to about 275 MPa (about 5000 psi to about 40000 psi), such as about 140 MPa (about 20000 psi). Mixing reagents under pressure in step (a) and/or step (b) of the process may assist with the rapid and thorough mixing of the reagents.

The use of high pressure flow and/or variable differential flow rates of reagents may allow for a uniform reaction to take place. The pressure and flow rate of reagents and the dimensions of the microfluidic reactor may be such that a turbulent flow of reagents is generated at the point at which the reaction takes place. Turbulent flow of reagents may thereby promote thorough mixing of the reagents and maintain consistent control of the reaction chemistry in a continuous microfluidic flow process. By maintaining consistent control of the reaction chemistry, we have been able to produce silver nanoparticles having physical characteristics within a well defined process envelope.

The microfluidic reactor, allows for the continuous flow and through mixing of reagents under controlled conditions thereby allowing a true scaling up of the reaction chemistry without compromising the quality of the nanoparticles produced. Advantageously, the thorough and rapid mixing of reagents allows for certain desired characteristics of the silver nanoparticles to be controlled and reproducibly produced. Such controlled reproducibility is not always possible in a conventional wet batch chemistry reaction in which reagents are mixed in higher volumes compared to the microfluidic process resulting in variations in nanoparticle characteristics both within a batch, and between batches.

Steps (a) and (b) can be combined in some embodiments of the invention to produce a single step microfluidic production method for these nanoparticles. The order of addition of the reagents, the type of reagents used, the concentration of the reagents can all be varied. Additional reagents can be introduced into the production steps. The microfluidics method allows for variations in the process parameters, these variations can be used to controllably tune various physical properties and attributes of the nanoparticles, such as their size, shape, thickness and optical spectrum.

The microfluidic methods enable the reproducible production of high definition silver nanoparticles with predetermined, size, shape, narrow distribution of size and shape. We have demonstrated that a microfluidics processor method can be used to produce discrete high definition silver nanoparticles in large volume batches. By tailoring pressure and shear rate parameters, silver nanoparticles can be produced on an industrial scale while retaining control of the reaction chemistry conditions necessary to produce controlled size and shape range silver nanoparticles. We used a high pressure (for example in the range of about 35 MPa to about 275 MPa, such as about 140 MPa), high shear rate (for example between about 1×10⁶ s⁻¹ to about 50×10⁶ s⁻¹, typically about 10⁷ s⁻¹) microfluidics processor method to produce silver nanoparticles in 500 ml batches. The process is capable of producing several liters per hour at flow rates typically in, the range of about 10 ml/minute to about 500 ml/minute, while a wet chemistry method is limited to 100 ml batch production.

### Shear Mixing

Nanoparticles can also be prepared by a shear mixing process comprising the steps of:
(a) forming silver seeds from an aqueous solution comprising a reducing agent, a stabiliser, a water soluble polymer and a silver source; and
(b) growing the thus formed seeds into silver nanoplates in an aqueous solution comprising silver seeds, a reducing agent and a silver source.
   wherein step (a) and/or step (b) are performed at a shear flow rate between about 1×10¹ s⁻¹ and about 9.9×10⁵ s⁻¹.

The invention is further illustrated with reference to the following non-limiting examples.

### EXAMPLES

### Example 1

### Microfluidic Production of Silver Seeds (Step (a))

We have found that by using microfluidics technologies for the production of silver seeds control over the synthesis of the silver seeds is the most important factor in producing discrete high definition silver nanoparticles with predetermined, size, shape and a narrow distribution of size and shape.

FIG. 1 is a schematic illustrating the set up for microfluidic synthesis of silver seeds.

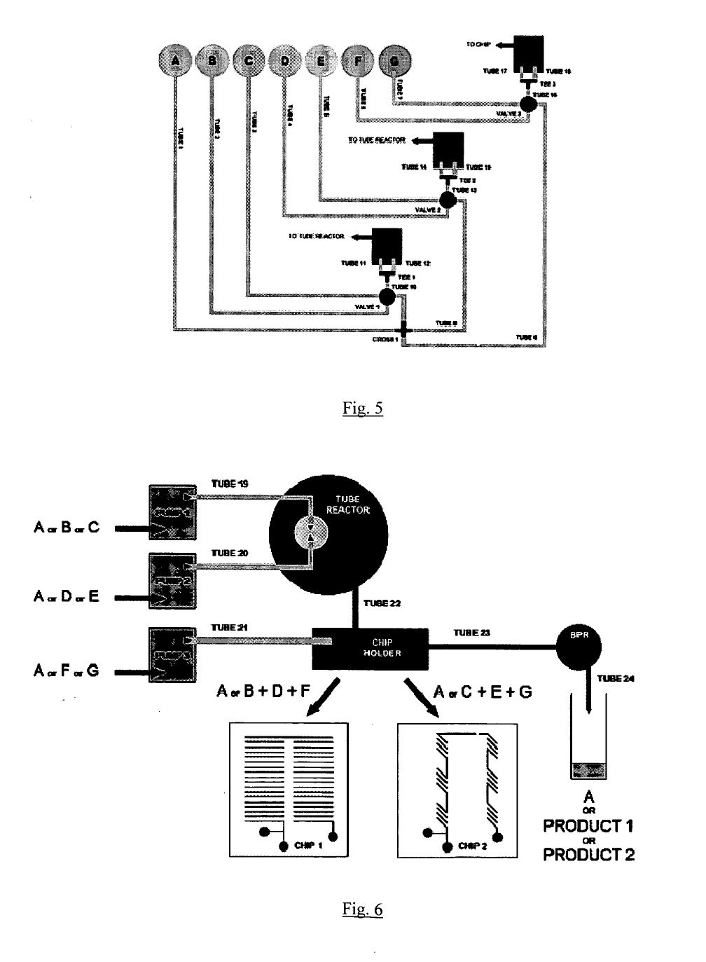

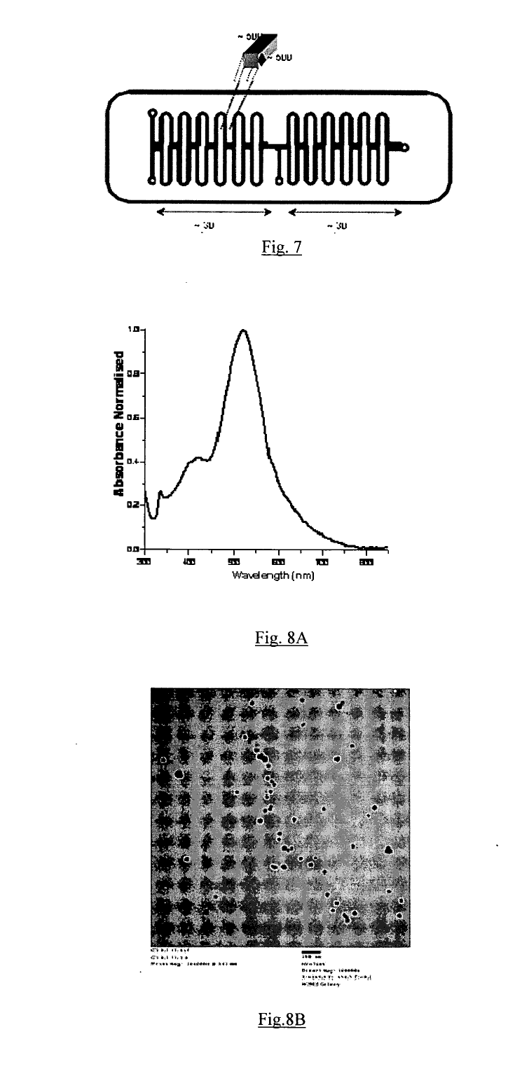

The second step (step (b)) of producing silver nanoparticles by growing silver seeds was in this case performed using conventional batch chemistry. The constituent chemicals and products may vary from those detailed in FIG. 1 wherein product 1 is a silver nitrate (AgNO₃) and Trisodium Citrate (TSC) solution and product 2 is a silver seed solution. Briefly, referring to FIG. 1, a silver source (in this case silver nitrate) is mixed with trisodium citrate at 0° C. Following mixing sodium borohydride (NaBH₄) is added to the AgNO₃-TSC solution and the mixture is incubated at 0° C. Specific details are outlined in Example 2 below. The microfluidics set-up for the production of the silver seeds is as shown in FIG. 3. This consists of a microfluidic reactor chip system (micromixer glass or polymer chips) to which the component solutions, such as those described in FIG. 1 are added at a controlled rate using pumps. The microfluidics chip may be of a generic type, i.e. an “off the shelf” chip that has not been specifically customized for the production of silver seeds or the growth of silver seeds to produce discrete high definition silver nanoparticles. Details of a suitable generic chip are given in FIG. 3B and in Table 1 below. Alternatively, the microfluidic chip may be custom designed for the production of silver seeds and/or the growth of silver seeds into nanoparticles. Referring to FIG. 7, a suitable chip is shown.

In an alternative process, product 1 is a sodium borohydride (NaBH₄) and Trisodium Citrate (TSC) solution and product 2 is a silver nitrate (AgNO₃) solution. The microfluidics set-up for the production of the silver seeds is as shown in FIG. 3A, this consists of a microfluidic reactor chip system (micromixer glass or polymer chips) to which the component solutions, such as those described in FIG. 1 are added at a controlled rate using pumps. The microfluidics chip may be of a generic type, i.e. an “off the shelf” chip, or a custom designed chip. Optionally, a polymer such as poly(sodiumstyrene sulfonate) (PSSS) may be added to step (a). For example, PSSS could be included in one or more of the silver nitrate solution, trisodium citrate solution, and sodium borohydride solution at a concentration of about 10⁻⁴ M.

TABLE 1
Suitable parameters of microfluidic chip

| Chip internal volume | 250 μl |
|---|---|
| Pressure rating | 30 Bar (450 psi) |
| Pressure drop across chip for water | 0.2 Bar |
| flowing at 100 ul/min | |
| Material | B270 |
| Number of glass layers | 2 |
| Channel fabrication | Double isotropic etch and thermal |
| | bond |
| Channel X-section | [symbol] |
| Hole fabrication | Mechanical drill |
| Channel shape | Circular |
| Channel depth/um | 250 |
| Mixing channel width/um | 300 |
| Mixing channel length/mm | 532 |
| Mixing channel pitch/um | 500 |
| Reaction channel width/um | 400 |
| Reaction channel length/mm | 2509 |
| Reaction channel pitch/um | 600 |

This method has enabled unprecedented reproducibility of the production of high definition of silver nanoparticles with predetermined, size, shape, narrow distribution of size and shape.

### Example 2

### Protocol for the Production of Silver Seeds (Step (a Using a Microfluidic Chip System

Referring to FIGS. 3A and 4, dissolve 37.8 mg of sodium borohydride in 100 ml of water (Solution 1 of FIG. 3A).

Dissolve 5 mg of silver nitrate and 7.4 mg of trisodium citrate in 100 ml of iced cooled water in an ice bath (solution 2 of FIG. 3A).

Connect solution 1 and solution 2 to pump 1 and pump 2 respectively (see setup of FIGS. 3A and 4).

Set pump 1 and pump 2 flow rates for example at 1 ml/min and 8 ml/min respectively;
Run pump 1 for 30 s and collect by-product;
Run pump 2, while pump 1 is still running and collect by-product for 30 s.

Collect 5 ml of final seed product, while pump 1 and pump 2 are still running.

Stop both pump 1 and pump 2.

A more generic setup for reagent input sequencing for general nanoparticle production is depicted in FIG. 5. This can be applied to the production method for of a wide range of nanoparticles including the methods of producing high definition silver nanoparticles. For general nanoparticle production the setup, setup conditions and reagents would need to be altered for each particular type of nanoparticle to be produced.

### Example 3

### Experimental Results for Application of Microfluidics Methods to Silver Seed Production (Step (a))

Results of experiments using a generic microfluidic chip system for the production of silver seeds (step (a)) are given below. In these cases the second step, (step (b))—the growth of these seeds to produce discrete high definition silver nanoparticles) is carried out using the conventional batch chemistry method.

In this example, silver seeds were synthesised using a generic microfluidic chip system according to the following method:

37.8 mg of sodium borohydride (0.01M) was dissolved in 100 ml of water (solution 1 of FIG. 3A). 5 mg of silver nitrate (2.94×10⁻⁴M) and 7.4 mg of trisodium citrate (2.5×10⁻⁴M) were dissolved in 100 ml of iced cooled water in an ice bath (solution 2 of FIG. 3A). Solution 1 and solution 2 were connected to pump 1 and pump 2 respectively (as shown in the setup of FIGS. 3A and 4). The flow rate of pump 1 was set at 1 ml/min under a pressure of about 2 MPa (20 bar). The flow rate of pump 2 was set at 8 ml/min under a pressure of about 2.5 MPa (25 bar).

Pump 1 was run for 30 s and the by-product collected. With pump 1 still running, pump 2 was run for 30 s and the by-product collected. Prior to stopping the pumps, 5 ml of final seed product was then collected while pumps 1 and 2 were still running.

In this example silver seeds were grown into nanoparticles (step (b)) using the conventional wet chemistry method below.

45 ml of 1 wt % polyvinyl alcohol (PVA) and 1.25 ml of 0.01M silver nitrate (AgNO₃) were placed in a 400 ml beaker equipped with a 5 cm magnetic stirrer. The beaker was placed on a hot plate set at 40° C. and the solution was stirred for 45 minutes in the dark. 0.5 ml silver seed solution from step (a) above was diluted with 5 ml PVA and added to the PVA-AgNO₃ solution. Approximately 30 s after the silver seed solution was added to the PVA-AgNO₃ solution 250 μl of 0.1M ascorbic acid was added to the mixture in one rapid shot.

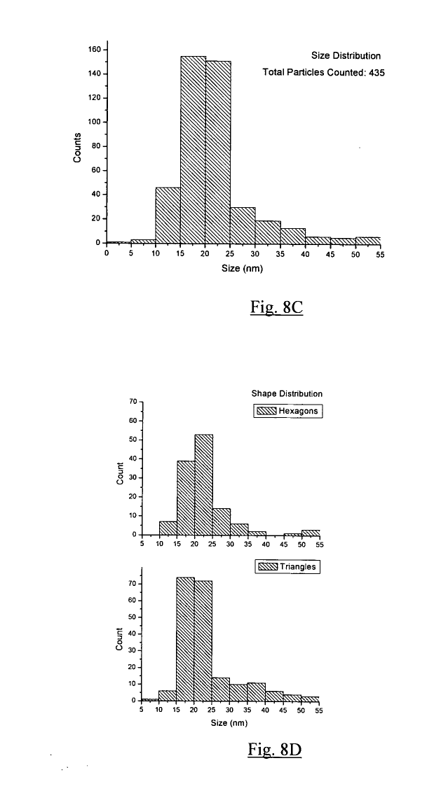

FIG. 8 shows the UV-visible spectrum and TEM image of discrete high definition silver nanoparticles produced using seeds produced by the generic microfluidic chip with a flow rate ratio of 8:1 for solution 1 and 2. The average nanoparticle size is 21.6±7.5 nm, with 75.4% of the nanoparticles being shaped, for example, triangular, truncated triangular and hexagonal. The FWHM of the main UV-visible spectral peak is 105 nm. The peak maximum wavelength is in the region of 520 nm.

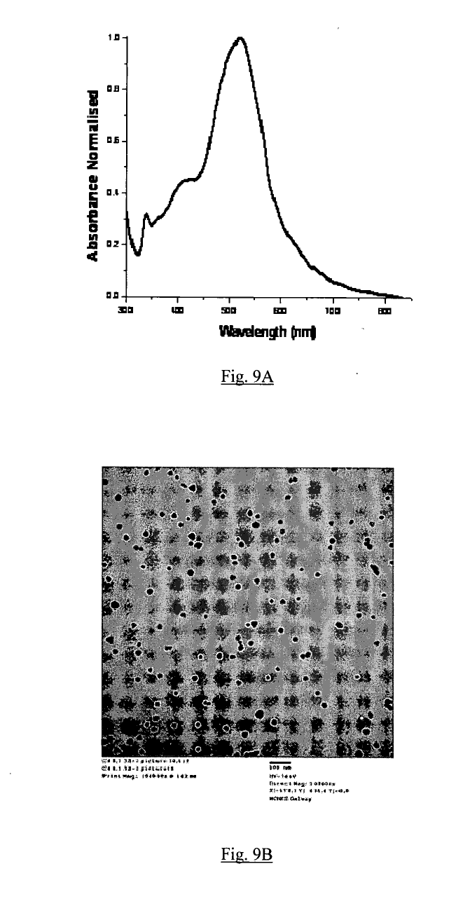

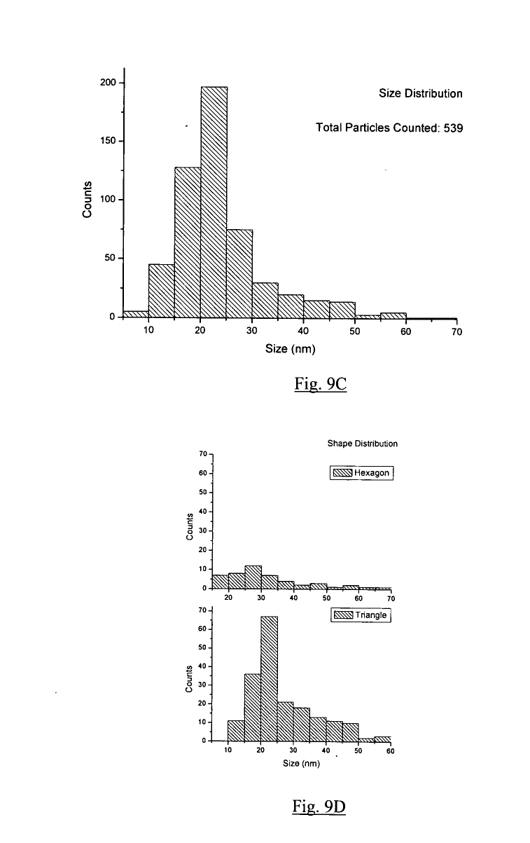

FIG. 9 shows the UV-visible spectrum and TEM image of discrete high definition silver nanoparticles produced using seeds produced by the generic microfluidic chip with a flow rate ratio of 8:1 for solution 1 and 2. The average nanoparticle size is 24.0±8.9 nm, with 44.9% of the nanoparticles being shaped, for example, triangular, truncated triangular and hexagonal. The FWHM of the main UV-visible spectral peak is 120 nm. The peak maximum wavelength is in the region of 519 nm.

The nanoparticles of FIGS. 8 and 9 demonstrate the ready reproducibility of discrete high definition silver nanoparticles with similar size, narrow size distribution and a high percentage of shaped nanoparticles, using a microfluidic method to produce the silver seed nanoparticles.

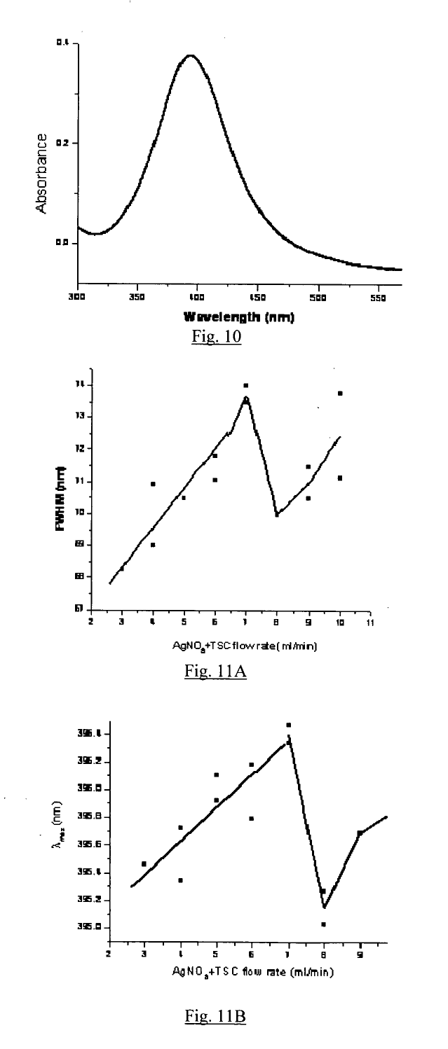

FIG. 10 Shows UV-visible spectra of microfluidic seeds produced using the generic microfluidic chip with a flow rate ratio of solution 1 and 2 of 8:1.

FIG. 11 shows the dependence of seed FWHM and maximum wavelength with variation of flow rate of solution 1 (AgNO₃ and TSC) from 3 to 10 ml/min while keeping flow rate of solution 2 constant at 1 ml/min.

Both in the case of FWHM and wavelength maximum an increase is observed as the flow rate of solution 1 is increased from 3 to 7 ml/min, follow by a sharp dip at 8/ml per min and a subsequent recovery to the increasing trend from 9 to 10 ml/min.

### Example 4

### Microfluidic Growth of Silver Seeds (Step b)

Due to blocking and clogging difficulties when using microfluidic chip systems for carrying out step (b), the growth of silver seeds to form discrete high definition silver nanoparticles a microfluidics processor method was selected for this step. A limited number of commercial microfluidics processors are available. The one selected is from a company Microfluidics located at 30 Ossipee Road, P.O. Box 9101 Newton, Mass. 02464-9101, U.S.A. This microfluidics processor operates at very high pressures of the order of 20,000 psi and provides high shear rates maximizing the energy-per unit fluid volume.

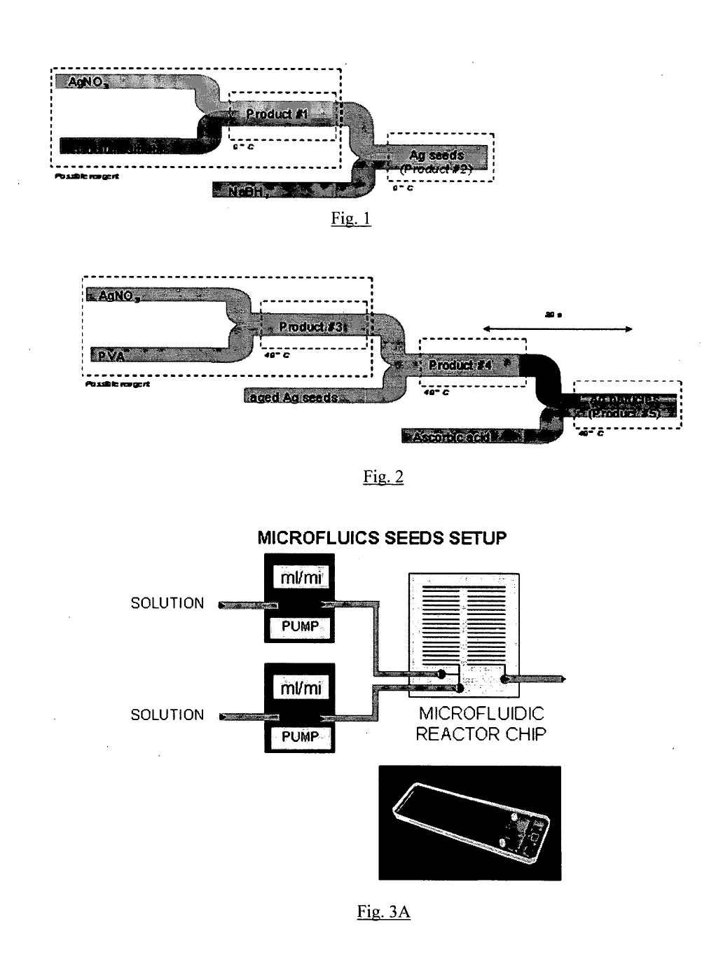

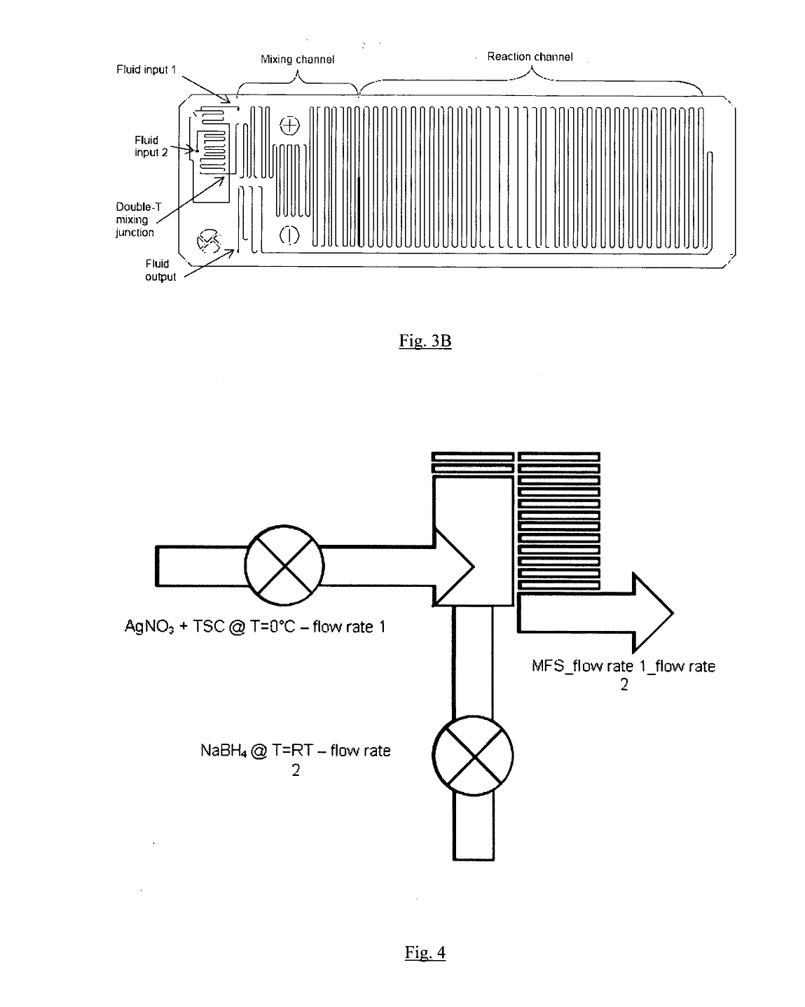

The complete method including a description of the discrete high definition silver nanoparticles, preferable properties of the silver nanoparticles to be produced, the reformulated of the protocol for discrete high definition silver nanoparticle production for application to microfluidic flow chemistry synthesis as shown in FIG. 2. It will be appreciated that the constituent chemicals and products may vary. However in this example:

Product 3 is a silver nitrate (AgNO₃) polyvinyl alcohol (PVA) solution Product 4 is a silver nitrate (AgNO₃) polyvinyl alcohol (PVA) and silver seed solution Product 5 is a solution of the discrete high definition silver nanoparticles

We used a microfluidics processor to carry out step (b), the growth of silver seeds to produce high quality discrete high definition silver nanoparticles. In this Example, the silver seeds were synthesised using a conventional wet chemistry method.

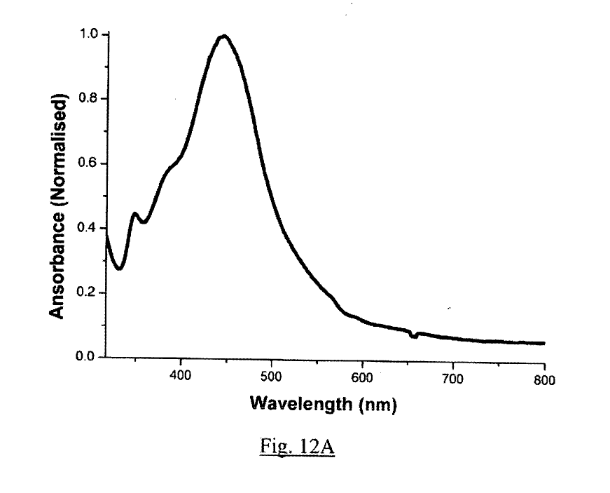

We used the Microfluidics International Corporation microfluidics processor technology to create a 500 ml batch of discrete high definition silver nanoparticle solution. Referring to FIGS. 12A and B, the average nanoparticle size was about 37±18 nm, with about 31% of the nanoparticles being shaped, for example, triangular, truncated triangular and hexagonal. The FWHM of the main UV-visible spectral peak was about 98 nm.

Blocking and clogging difficulties were encountered in some experiments when a microfluidic chip systems was used for carrying out step (b), the growth of discrete high definition silver nanoparticles from silver seeds. It was found that blocking and clogging of the microfluidic system could be overcome if the reagents were under pressure for this step. In this Example we used a microfluidics system supplied by a company now known as Microfluidics International Corporation located at 30 Ossipee Road, P.O. Box 9101 Newton, Mass. 02464-9101, U.S.A. This microfluidics processor operates at very high pressures of the order of about 140 MPa (about 20,000 psi) and provides high shear rates in the range of about 1×10⁶ s⁻¹ to about 50×10⁶ s⁻¹, thereby maximizing the energy-per unit fluid volume.

The microfluidics processor used allowed the reagent streams to be pressurized so that the reagent streams traveled at high velocities to meet in a reaction chamber where turbulent mixing took place. The microfluidics processor also allowed for continuous flow of the reaction product (silver nanoparticles). Details of typical processor operating parameters are given in Table 2 below.

TABLE 2
Suitable parameters of microfluidics processor

| | |
|---|---|
| Pressure range | 35 MPa to 275 MPa |
| | (5,000 psi to 40,000 psi) |
| Flow rate range | 10 ml/min to liters/min |
| Typical fluid velocity | 1.2-20 m/s up to 500 m/s |
| Typical resident time | 0.5-1 ms down to 2 μs |
| Typical shear rate | 1-50 × 10⁶ s⁻¹ |

FIG. 2 shows a microfluidic system set up for growing nanoparticles from silver seeds. Whilst it will be appreciated that the constituent chemicals and products may vary, in this Example product 3 is a silver nitrate (AgNO₃) polyvinyl alcohol (PVA) solution, product 4 is a silver nitrate (AgNO₃) polyvinyl alcohol (PVA) and silver seed solution, and product 5 is a solution of the discrete high definition silver nanoparticles.

A TEM image of the silver nanoparticles produced (product 5) is shown in FIG. 12B.

### Example 5

### Experimental Results for Application of Microfluidics Methods to Silver Seed Growth (Step (b)) for the Production of Discrete Silver Nanoparticles

The objective was using the microfluidics processor to carry out step (b), the growth of silver seeds, which were produced using a conventional wet chemistry method, to produce high quality discrete high definition silver nanoparticles.

We used Microfluidics Inc microfluidics processor technology described in Example 4 above to create a 500 ml batch of discrete high definition silver nanoparticle solution. The average nanoparticle size is 37±18 nm, with 31% of the nanoparticles being shaped, for example, triangular, truncated triangular and hexagonal. The FWHM of the main UV-visible spectral peak is 98 nm.

We have demonstrated that a microfluidics processor method can be used to produce discrete high definition silver nanoparticles in large volume batches. Thus, the silver nanoparticles can be produced on an industrial scale. We used a microfluidics processor method to produce 500 ml batches in a few minutes only. The process is capable of producing several liters per hour, while the wet chemistry method is limited to 100 ml production.

### Example 6

### Application of Microfluidics Methods to Both Silver Seed Production (Step a) and Silver Seed Growth (Step (b)) for the Production of Discrete Silver Nanoparticles

The Microfluidics International Corporation microfluidics processor technology described in Example 4 was also applied to the production of silver seeds (step (a)) and in a further stage these microfluidic processor produced seeds were grown to produce discrete silver nanoparticles (step (b)) also using a microfluidics processor. Thus we have successfully used microfluidics methods to carry out the complete process for producing discrete high definition silver nanoparticle i.e. both steps (a) and (b). Referring to FIG. 6 a generic set up for reagent input sequencing for the synthesis of high definition nanoparticles is shown.

In this example the following method was used:

Step (a)—Synthesising Silver Seeds

A solution comprising 2.94×10⁻⁴M AgNO₃ and 2.5×10⁻⁴M TSC and 10⁻⁴M PSSS in water was made and poured into the reservoir of a microfluidics processor. A 0.01M solution of NaBH₄ was introduced into the microfluidics processor. The NaBH₄ and AgNO₃-TSC solutions were mixed at flow rates of 15 ml/min and 485 ml/min respectively with a continuously flowing stream of the AgNO₃-TSC solution and the material was processed for one pass at 140 MPa (20,000 psi).

Step (b)—Growing Silver Nanoparticles

An aqueous solution of 1 wt % PVA, 0.01M AgNO₃ and 10⁻⁴ M PSSS in water was made in a beaker equipped with a magnetic stir bar (the total volume was 500 ml). The beaker was placed on a hot plate set at 40° C. and stirred for 45 minutes in the dark. 5 ml if silver seed solution from step (a) above was diluted in 50 ml PVA and added to the beaker.

Approximately 30 s after the silver seed solution was added to the beaker, the PVA-AgNO₃-PSSS-silver seed solution was placed in the reservoir of a microfluidics processor. A 0.01M solution of ascorbic acid solution was introduced to a 475 ml/min continuously flowing stream of PVA-AgNO₃-PSSS-silver seed solution at a rate of 25 ml/min. The material was processed for 1 pass at 35 MPa (20,000 psi).

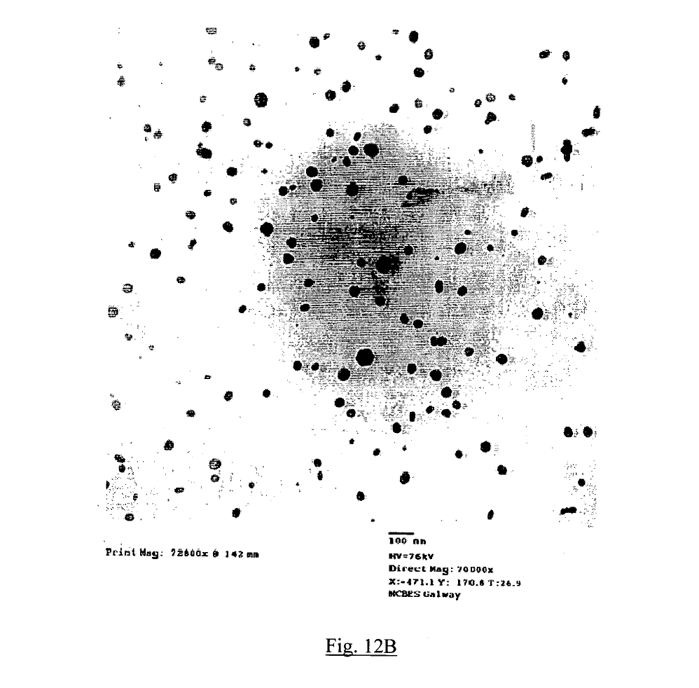

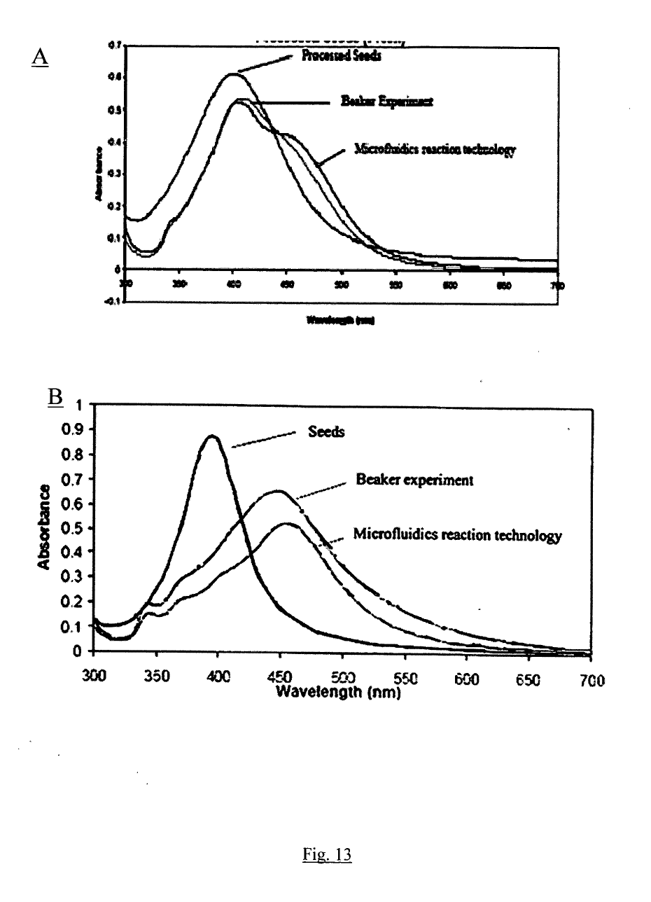

The UV-visible spectrum of silver seeds produced using a microfluidics processor (processed seeds) and the discrete high definition silver nanoparticles produced by the subsequent growth of these microfluidics processor produced silver seeds also using a microfluidics processor (microfluidics reaction technology) are shown in FIG. 13A. Also shown are discrete silver nanoparticles produced by the conventional wet chemistry growth of the microfluidic processor synthesized silver seeds (beaker experiment). It is clear from the spectra shown in FIG. 13A that the microfluidic process of growing the microfluidic synthesized silver seeds (i.e. using a microfluidics process for both steps (a) and (b)) results in the production of discrete silver nanoparticles with a much higher presence of shaped silver nanoparticles compared to a conventional wet chemistry operation of the growth step as is signified by the much more distinct peak in the region of 345 nm in the case of the microfluidics processor produced discrete silver nanoparticles and a much larger shoulder plasmon band in the 450 nm region.

Referring to FIG. 13B, a silver seed solution was synthesised using a conventional wet chemistry method (seeds) and discrete silver nanoparticles were prepared by either using a conventional wet chemistry method for growing the wet chemistry synthesised silver seeds (beaker experiment) or a microfluidic processor for growing conventionally synthesized silver seeds. It is clear again from the spectra shown in FIG. 13B that using a microfluidics process for step (b) results in the production of discrete silver nanoparticles with a high presence of shaped silver nanoparticles compared to a conventional wet chemistry method.

### Example 7 (Comparative Example)

### Wet Chemistry Batch Nanoparticle Production Both Step (a) and Step (b)

A wet chemistry method was used to synthesize silver seeds (step (a)) and growing the silver seeds to form discrete silver nanoparticles (step (b)), as described in WO04/086044. Briefly, silver seeds were formed by vigorously stirring an aqueous mixture of silver nitrate, trisodium citrate and sodium borohydride. The typical ratio of silver nitrate:trisodium citrate was about 1:1 and the typical ratio of silver nitrate:sodium borohydride was about 1:8.

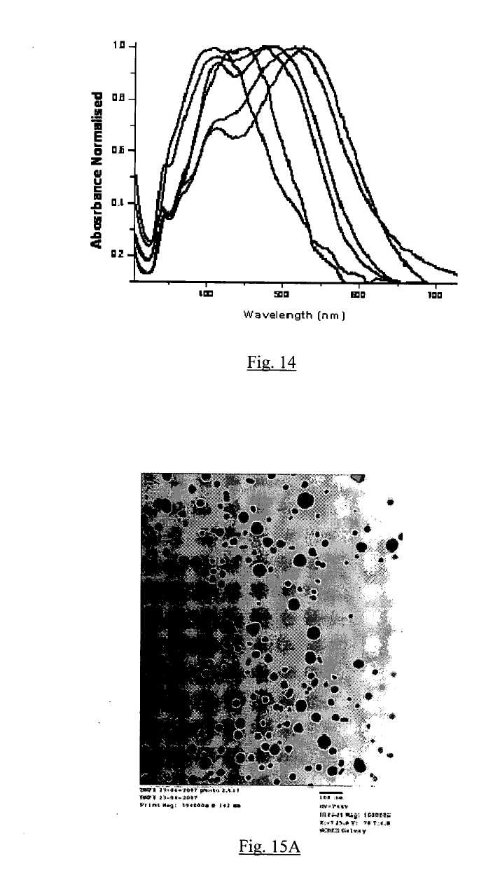

The batch wet chemistry method restricts the production volume generally to the order of 50 ml, with a maximum of up to 100 ml of discrete silver nanoparticles being produced in any one batch. Batch to batch reproducibility difficulties are experienced, as indicated by the diverse range of UV-Visible spectra of discrete silver nanoparticles using wet chemistry prepared under precisely the same conditions as shown in FIG. 14. These batches of discrete silver nanoparticles have spectra, whose maximum peak wave lengths range between 400 nm and 700 nm, have FWHM in excess of 150 nm and have spectra which vary between single peaked to twin peaked where both spherical and shaped associated peaks are of similar intensity to the case where the shaped associated peak is dominant.

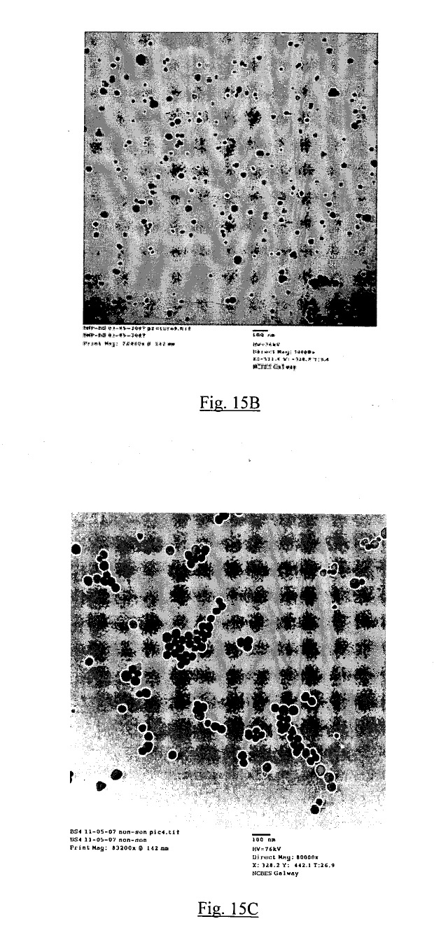

FIG. 15 shows representative TEM images of discrete silver nanoparticles prepared using wet chemistry in steps (a) and (b) (wide size distribution (FIGS. 15 A and B) and low presence of shaped nanoparticles (FIG. 15 C). We have found that only rarely, in about 1 in 50 batches, are discrete silver nanoparticles with characteristics which approach those of the discrete silver nanoparticles produced by conventional wet chemistry achieved using the microfluidics methods when the wet chemistry method is applied to both steps (a) and (b), in particular to step (a), silver seed production, in process of discrete silver nanoparticle production. This is in direct contrast to the results for the microfluidic methods for discrete silver nanoparticle production where discrete silver nanoparticles with narrow size distribution, high percentage of shaped nanoparticles and very similar UV-visible spectral profiles with peak maximum wavelengths within 1 nm can be readily prepared, as indicated by the discrete silver nanoparticles shown in FIGS. 8 and 9.

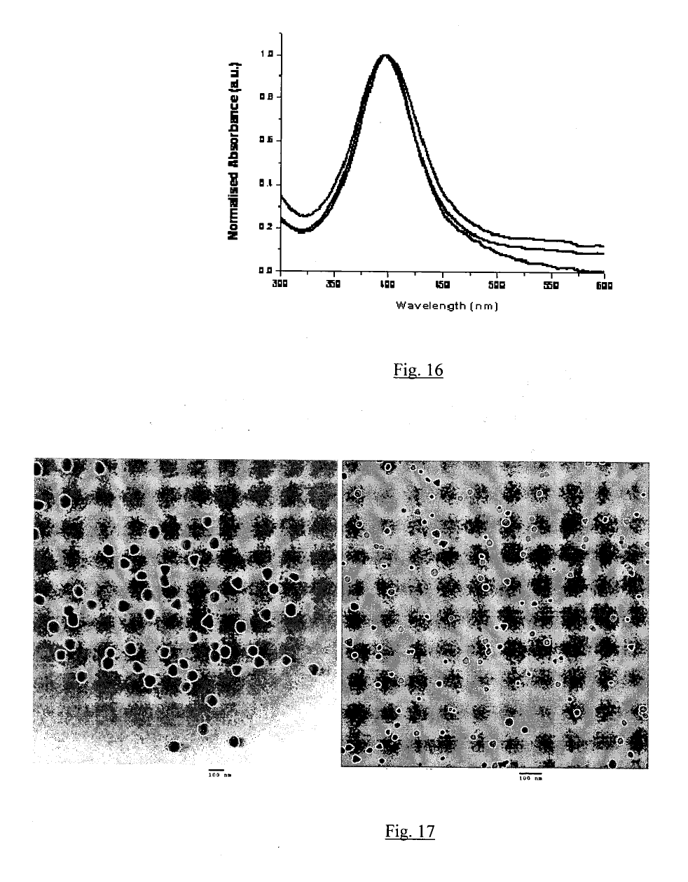

FIG. 16 shows UV-visible spectra for three different batches of silver seeds produced under the same conditions using conventional wet chemistry. The spectra profiles are very similar with a peak maximum wavelength in the region of 399 nm and a FWHM of the order of 65 nm. These silver seeds are typical of those used in the wet chemistry step (b) resulting in discrete silver nanoparticles which have the range of variation and poor reproducibility shown in FIGS. 14 and 15.

Referring to FIGS. 10 and 16, the UV-visible spectra of wet chemistry (FIG. 16) and microfluidic (FIG. 10) produced silver seeds appear to be comparable. However, we have found major differences in the performance of the wet chemistry and microfluidic produced silver seeds in terms of, reproducibility, control over size, shape, size and shape distribution, percentage of shaped and unshaped nanoparticles present in discrete silver nanoparticle batches produced subsequently from the seeds, either by employing conventional wet chemistry or microfluidics methods to carry out step (b), the growth of the silver seeds to from discrete silver nanoparticles. We have found that the control and precision afforded by microfluidics methods for the production of silver seeds is key in achieving discrete silver nanoparticles with the required characteristics, controlled size, narrow size distribution, high presence of shaped nanoparticles and good batch to batch reproducibility. Thus, microfluidics methods, such as microfluidics processors, can be readily applied to produce litres per hour of the discrete silver nanoparticles with out sacrificing quality.

### Example 8

### Process for Selectively Producing Nanoplates

The process for synthesizing nanoparticles may be tailored for the selective production of nanoplates, in particular the synthesis process may be tailored for the selective production of triangular silver nanoplates. The following methods result in the production of triangular silver nanoplates as the dominant nanostructure.

### Wet Chemistry

Triangular Silver Nanoplates (TSNP) can be prepared according to the seed mediated methods described in PCT/IE2008/000097, the entire contents of which is incorporated herein by reference.

In this particular example, TSNP were prepared as follows: 5 ml of 2.5 mM trisodium citrate, 250 μL of 500 mg.L⁻¹ 1,000 kDa poly(sodium styrenesulphonate) (PSSS) and 300 μL of freshly prepared 10 mM NaBH₄ were combined followed by addition of 5 mL of 0.5 mM AgNO₃ at a rate of 2 ml.min⁻¹ while stirring vigourously.

The triangular silver nanoplates were grown by combining 5 mL distilled water, 75 μl of 10 mM freshly prepared ascorbic acid and various quantities of seed solution followed by addition of 3 mL of 0.5 mM AgNO₃ at a rate of 1 ml.min⁻¹. Followed by the addition of 0.5 ml of 25 mM Trisodium citrate.

The size of the TSNP can be controlled by adjusting the volume of seeds used in the growth step.

### Microfluidics

TSNP can be prepared according to the seed mediated microfluidics methods described in PCT/IE2008/000097, the entire contents of which is incorporated herein by reference.

Briefly, microfluidic synthesis of TSNP comprises the steps of:
(a) forming silver seeds from a silver source and a reducing agent; and
(b) growing the thus formed silver seeds into TSNP

A generic microfluidic chip system was used for the production of TSNP using the following experimental parameters:

### Step (a)

A mixture of 3 mL of 10 mM sodium borohydride, 2.5 mL of 500 mgL⁻¹ poly(sodiumstyrene sulfonate) and 100 mL of 2.5×10⁻³M trisodium citrate in water (solution 1) was prepared and connected to pump 1. A solution comprising 100 ml of 5×10⁻⁴ M silver nitrate (solution 2) was prepared and connected to pump 2, The flow rates of pump 1 and pump 2 were set for example at 1 ml/min and 1 ml/min respectively. The pump lines were primed with the solution to be used in them and pump 1 and pump 2 were run in succession for ˜2 min each such that an initial volume of ˜2 mL of each solution was run through the microfluidic chip and discarded. Pump 1 and pump 2 were run together and the first 1 ml of the product solution was discarded. The subsequent 5 ml of seed product was collected and both the pumps were stopped.

### Step (b)

5 mL of water, 75 μL of 10 mM ascorbic acid and 100 μL of the seeds from step (a) were stirred together in a beaker using a magnetic at a rate of 500 rpm a. 3 mL of silver nitrate 5×10⁻⁴ M was added at a rate of 1 mLmin⁻¹. 500 μL 2.5×10⁻²M trisodium citrate was then added to stabilize the particles and the final volume was brought up to 10 mL using water.

The size of the TSNP can be controlled by adjusting the volume of seeds used in the growth step (step (b)).

Step (a) and/or step (b) may be carried out using a high pressure microfluidics process which would enable the production of large volumes of TSNP.

### Shear Mixing

In an exemplary example, silver seeds were produced in a shear mixer having the following parameters: Speed 16,000 rpm Gap size 0.15 mm, Radius of outer gap 15.05 mm, 15 cuttings/360° Shear rate 1.68×10⁵ s⁻¹; Shear frequency 3.36 Mio. Min⁻¹. A suitable shear mixer is sold by IKA process under item Magic Lab UTL 6F.

To produce the silver seeds, H₂O (90 mL), TSC (10 mL, 25 mM), NaBH₄ (6 mL, 10 mM) and PSSS (5 mL, 0.5 mg/mL) were combined in a beaker. This solution was then transferred into the mixing chamber of a shear mixer. The motor was switched on at a tip speed of 23 m/s and the solution was allowed to circulate for about 2 minutes. AgNO₃ (100 mL, 0.5 mM) was then introduced through an adapted inlet at a rate of 40 ml/min using a peristaltic pump. After the AgNO₃ addition was complete, the solution was allowed to circulate for approximately 5 min before being tapped off. During the initial recirculation the cooling system was switched on so that the growth was carried out at about 25° C.-30° C. The seeds were allowed to age for 1 h before further use.

In an exemplary example, silver nanoplates were produced in a shear mixer having the following parameters: Speed 16,000 rpm Gap size 0.15 mm, Radius of outer gap 15.05 mm, 15 cuttings/360° Shear rate 1.68×10⁵ s⁻¹; Shear frequency 3.36 Mio. Min⁻¹. A suitable shear mixer is sold by IKA process under item Magic Lab UTL 6F. A 1 L scale production of silver nanoplates at a concentration of 17 ppm were grown from silver seeds as follows:

To produce silver nanoplates, H₂O (500 mL), seeds (30 mL) and ascorbic acid (7.5 mL, 10 mM) were combined and then added to the mixing chamber of a shear mixer. This solution was then circulated at a shear rate of 1.68×10⁵ s⁻¹ for about 2 min and AgNO₃ (300 mL, 0.5 mM) was added at a rate of 100 mL/min using a peristaltic pump. Two minutes after the addition of AgNO₃ was complete, TSC (200 mL, 25 mM) was added using the peristaltic pump and the sol was allowed to recirculate for a further 2 minutes before being tapped off.

The reagent volumes and concentrations and process parameters may be modified. The size of the TSNP can be controlled by adjusting the volume of seeds used in the growth step. In general, the solutions may be mixed at a shear flow rate between about 1×10¹ s⁻¹ and about 9.9×10⁵ s⁻¹.

### Example 9

### Properties of Triangular Silver Nanoprisms

The silver nanoprisms produced in accordance with the methodologies of Example 8 are monodisperse (discrete), well-defined silver nanoprisms of varying edge length. The triangular silver nanoplates have an aspect ratio from about 2 to about 25 with increasing edge length wherein aspect ratio is the ratio of the edge length and thickness of a nanoplate and is calculated using equation 1 below.

Aspect ratio is the ratio of the length and thickness of nanoplate and is calculated using equation 1 below.

Aspect ratio=Edge length (Equation 1)

Thickness

One of the advantages associated with high aspect ratio is that it enables the preservation of the quantum confinement effects in nanoplates that would otherwise enter the bulk regime due to the size of the nanoplate. Nanoplates having a high aspect ratio means that larger nanoplates retain many of the optical and electronic properties normally only associated with smaller nanoparticles.

### Example 10

### Production of an Ink

The process for making the ink comprises the steps of:
(a) production of the silver seeds
(b) growth of the silver seeds to form the nanoparticles, in solution, which constitute the ink
(c) further dispersion of the nanoparticles within the ink by the addition of chemical, biological or polymer species

It will be apparent that steps (a) and (b) may be performed in accordance with any of methodologies outlined in Examples 1 to 8 above and once the nanoparticles have been produced, step (c) can be performed. In this particular example, both steps (a) and (b) were performed using microfluidic processing as follows.

Step (a)—Microfluidic Production of Silver Seeds (Step a)

We have found that by using microfluidics technologies for the production of silver seeds control over the synthesis of the silver seeds is the most important factor in producing discrete high definition silver nanoparticles with predetermined, size, shape and a narrow distribution of size and shape

FIG. 1 is a schematic illustrating the set up for microfluidic synthesis of silver seeds.

### Protocol for the Production of Silver Seeds Using a Microfluidic Chip System

Dissolve 37.8 mg of sodium borohydride in 100 ml of water (“Solution 1”).

Dissolve 5 mg of silver nitrate and 7.4 mg of trisodium citrate in 100 ml of iced cooled water in an ice bath (“solution 2”).

Connect solution 1 and solution 2 to pump 1 and pump 2 respectively of a microfluidic reactor

Set pump 1 and pump 2 flow rates for example at 1 ml/min and 8 ml/min respectively;
Run pump 1 for 30 s and collect by-product;
Run pump 2, while pump 1 is still running and collect by-product for 30 s.

Collect 5 ml of final seed product, while pump 1 and pump 2 are still running.

Stop both pump 1 and pump 2.

Step (b)—Microfluidic Growth of Silver Seeds

FIG. 2 is a schematic illustrating the set up for microfluidic synthesis of silver nanoparticle ink.

A commercial microfluidics processor (such as that supplied by Microfluidics, Inc., 30 Ossipee Road, P.O. Box 9101 Newton, Mass. 02464-9101, U.S.A.) operated at very high pressures of the order of 20,000 psi and providing high shear rates maximizing the energy-per unit fluid volume, was used to make the ink from the seed solution.

It will be appreciated that the constituent chemicals and products may vary from those described however, in this particular example:

Product 3 is a silver nitrate (AgNO₃) polyvinyl alcohol (PVA) solution

Product 4 is a silver nitrate (AgNO₃) polyvinyl alcohol (PVA) and silver seed solution

Product 5 is a solution of the discrete high definition silver nanoparticles

This methodology can be applied to the production of a wide range of nanoparticles including the methods of producing high definition silver nanoparticles. For general nanoparticle production the setup, setup conditions and reagents would need to be altered for each particular type of nanoparticle to be produced.

The constituent chemicals and products may vary from those detailed in FIG. 1 wherein product 1 is a silver nitrate (AgNO₃) and Trisodium Citrate (TSC) solution and product 2 is a silver seed solution. Briefly, referring to FIG. 17, a silver source (in this case silver nitrate) is mixed with trisodium citrate at 0° C. Following mixing sodium borohydride (NaBH₄) is added to the AgNO₃-TSC solution and the mixture is incubated at 0° C. The microfluidics set-up for the production of the silver seeds consists of a microfluidic reactor chip system (micromixer glass or polymer chips) to which the component solutions, such as those described in FIG. 1 are added at a controlled rate using pumps. The microfluidics chip may be of a generic type, i.e. an “off the shelf” chip that has not been specifically customized for the production of silver seeds or the growth of silver seeds to produce discrete high definition silver nanoparticles. Details of a suitable generic microfluidic chip are given in Table 3 below.

TABLE 3
Suitable parameters of microfluidic chip

| Chip internal volume | 250 μl |
|---|---|
| Pressure rating | 30 Bar (450 psi) |
| Pressure drop across chip for water | 0.2 Bar |
| flowing at 100 ul/min | |
| Material | B270 |
| Number of glass layers | 2 |
| Channel fabrication | Double isotropic etch and thermal |
| | bond |
| Channel X-section | Rounded corner rectangle |
| Hole fabrication | Mechanical drill |
| Channel shape | Circular |
| Channel depth/um | 250 |
| Mixing channel width/um | 300 |
| Mixing channel length/mm | 532 |
| Mixing channel pitch/um | 500 |
| Reaction channel width/um | 400 |
| Reaction channel length/mm | 2509 |
| Reaction channel pitch/um | 600 |

This method has enabled unprecedented reproducibility of the production of high definition of silver nanoparticles with predetermined, size, shape, narrow distribution of size and shape.

Step (c) Nanoparticle Concentration and/or Dispersion

Further development of the nanoparticle ink may be performed by optionally concentrating the nanoparticles, for example by means of centrifugation, and by the addition of chemical, biological or polymer species, for example, polyethylene oxide.

### Example 11

### High Volume Ink Production

A Microfluidics Inc microfluidics processor technology as described above was used to create a 500 ml batch of discrete high definition silver nanoparticle solution. The average nanoparticle size is 37±18 nm, with 31% of the nanoparticles being shaped, for example, triangular, truncated triangular and hexagonal.

The microfluidics processor method can be used to produce discrete high definition silver nanoparticles in large volume batches. Thus, the silver nanoparticles can be produced on an industrial scale. We used a microfluidics processor method to produce 500 ml batches. The process is capable of producing several litres per hour.

### Example 12

### Production of Various Formulations of Nanoparticle Inks

A microfluidics processor technology as described above was used to create seven batches of discrete high definition silver nanoparticle solutions of varied formulation, as described in Table 4.

TABLE 4
Seven example formulations
of silver nanoparticle inks which were produced

| | PSSS | Seed Volume | Silver Nitrate:Trisodium Citrate |
|---|---|---|---|
| Formulation | (mg) | (μl) | ratio |
| 1 | 20 | 250 | 1:1 |
| 2 | 5 | 500 | 1:2 |
| 3 | 20 | 500 | 1:2 |
| 4 | 100 | 500 | 1:2 |
| 5 | 10 | 500 | 1:1.5 |
| 6 | 10 | 500 | 1:2 |
| 7 | 10 | 500 | 1:1 |

The ink may comprise a solution or suspension or mixture of nanoparticles in a liquid wherein said nanoparticles have a distribution of geometric shapes within which either two or more shape geometries, or in preferred embodiments of the invention one shape geometry, selected from one of the following list, are/is predominant:
a. spherical;
b. ellipsoidal;
c. circular plate shaped;
d. elliptical plate shaped;
e. tetragonal;
f. triangular;
g. hexagonal;
h. tetragonal plate;
i. triangular plate;
j. hexagonal plate;
k. cubic;
l. other flat polygonal;
m. other three-dimensional volume shape

The three characteristic dimensions of height, length and width or equivalent, of nanoparticles dispersed in the ink are under 500 nm for each particle. An important aspect of the inks is that they contain nanoparticles of a controlled shape. In most cases the height dimension is much smaller than the other principal dimensions (length and/or width) but in general all principal dimensions of the nanoparticles are under 500 nm. In one embodiment the ink comprises silver nanoplates with one shape geometry, selected from the following is predominant:
a. circular plate shaped
b. elliptical plate shaped
c. triangular plate shaped
d. hexagonal plate shaped
e. other flat polyglonal plate shaped.

In one aspect, the inks are electrically conducting inks and may be used to form electrically conducting structures. In a further aspect the inks are thermally conducting and can be used to generate thermally conducting paths.

The methods to generate nanoparticles described herein allow for the control of the range of sizes and/or shapes of particles as defined by one or more of their principal dimensions (height, length and width.) The ability to control of size and shape of nanoparticles can be exploited to produce inks having specific properties for example, by adjusting the concentration of the nanoparticles in the ink may provide for an ink that when printed will have an electrically conductive path, while minimising the metal nanoparticle content of the ink.

As the size and/or shape of the nanoparticles in the ink can be controlled, the inks described herein allow for narrow conductive paths or lines or wires or structures to be made or printed. The width of a conductive path can be reduced to a dimension comparable to the size of the nanoparticles. It is feasible that conductive paths with a width of less than 100 nm may be fabricated from the inks described herein. In some embodiments of the invention, chemical or biological substances may be added to the ink to promote the aggregation or self-assembly of the nanoparticles to make conductive paths. In other embodiments, the ink may be allowed to form a conductive path without additional chemical or biological agent treatment after deposition. In other embodiments, the ink may be deposited on a structured surface, such as a polymer, in which the surface structure assists the formation of conductive paths from the ink.

The invention further provides for the formulation of an ink comprising metal nanoparticles at a concentration consistent with a low probability of the formation of a conductive path. For certain applications it is desirable to have metal nanoparticles present on a material, but deposited in such a way that they do not make a conductive path. It is possible to form an ink containing metal nanoparticles that is not conductive because the nanoparticles are discrete, and because their size and shape may be controlled within sufficiently narrow ranges.

The production of large volumes of stable, highly discrete, dimension and shape controlled silver nanoparticles in an aqueous forming high specification ink containing unique high quality readily dispersible silver nanoparticles, has been demonstrated for example using a high pressure microfluidic reactor.

The inks described herein may be used in a wide variety of applications described below.

Current commercially available nanoparticles inks and silver nanoparticles generally comprise very non-uniform particles which have a large size dispersion and low specificity. Dispersion of such nanoparticles to form and ink is notoriously difficult with aggressive techniques often required, if indeed dispersion is at all possible.

### Example 13

### Silver Nanoparticle Ink

The images in FIG. 17 illustrate an example of the characteristics of the silver nanoparticle ink of the invention as deposited in a TEM analysis grid. The nanoparticles are dispersed, discrete, nanoparticles whose predominant shape and size are well controlled.

Structural characterisation of the silver nanoparticle ink was undertaken using Transmission Electron Microscopy (TEM), Atomic Force Microscopy (AFM) and Dynamic Light Scattering (DLS). Analysis of the images obtained using Image Tool image analysis software was performed to measure the mean diameter of the particles, and its standard deviation. The TEM image shows a sample batch of silver nanoparticle ink comprising a mixture of silver nanoparticle plate shapes including triangular, truncated triangular and circular discs showing a narrow size distribution about a median of 24 nm in a polymer (polyvinyl alcohol) in aqueous solution. The size of the silver nanoparticles can be controlled to range from about 5 nm to 100 nm and have a relatively narrow size distribution with aspect ratios which range from 1 to 10.

The excellent dispersability and miscibility of the silver nanoparticles within inks is evident from TEM images and also from SEM images of films spun from such inks. Different aqueous based high viscosity polymer inks were prepared confirmed and surface chemistry compatibility was ascertained using zetapotential studies.

Samples of the ink were prepared, centrifuged down to remove the ink medium, and suspended in water before being dropped onto a TEM grid and allowed to dry.

FIG. 18 displays an example of a histogram used to represent the diameter distribution of nanoparticle samples and determine their mean diameter, determined from TEM image analysis as described in Table 5.

TABLE 5
Analysis of TEM Data for seven different ink formulations

| | Mean d | Std Dev |
|---|---|---|
| Sample | (nm) | (nm): |
| 1 | 32.78 | 11.15 |
| 2 | 30.46 | 9.95 |
| 3 | 23.07 | 9.37 |
| 4 | 27.81 | 9.48 |
| 5 | 31.03 | 12.73 |
| 6 | 37.39 | 15.98 |
| 7 | 39.68 | 18.17 |

Table 5 above gives a range of mean diameter of the nanoparticles and its standard deviation for seven different silver nanoparticle inks, determined from image analysis of TEM data.

Nanoparticle heights were measured from several different sections of the Si substrate, for seven different silver nanoparticle inks, and are shown in Table 6.

TABLE 6
AFM Analysis of silver nanoparticle component
of for seven different ink formulations

| | Mean Height | |
|---|---|---|
| Sample | (nm) | Std Dev: |
| 1 | 15.39 | 5.54 |
| 2 | 17.16 | 5.31 |
| 3 | 15.24 | 5.07 |
| 4 | 13.37 | 5.8 |
| 5 | 17.67 | 5.96 |
| 6 | 16.48 | 5.58 |
| 7 | 16.75 | 6.22 |

The effective sizes recorded for the silver nanoparticles using Dynamic Light Scattering (DSL) are much larger, by a factor of three to four, than those visible in the TEM analysis. This is evidence of the high dispersability and chemical compatibility of silver nanoparticles with the ink medium, which in this case is the polymer polyvinyl alcohol. The nanoparticles are effectively suspended in the polymer medium so that the polymer inhibits the motion of the nanoparticles resulting in them appearing to move slower than they otherwise would for their true size (provided by AFM and TEM analysis) causing them to appear larger than they actually are. The DSL diameter results are not so large as to indicate aggregation or agglomeration, which is also confirmed by the TEM analysis as evidenced in FIG. 17.

Zeta potential theory states that nanoparticles with a zeta potential <−20 mV or >+20 mV are electrostatically stable. The silver nanoparticle inks have been prepared and observed to remain stable over periods of years.

Two different types of studies were undertaken for the Zeta Potential analysis of inks 1) Zeta Potential dependence on concentration (Table 7); 2) Zeta Potential dependence on centrifiguration/removal of polymer (Table 8).

Table 7 displays the results for the zeta potential vs. concentration analysis on an ink. From these results we can see that as the ink is diluted down with water the zeta potential is increased. This indicates as the ink is diluted the polymer which is acting to shield the true zeta potential is reduced hence increasing the measured zeta potential of the ink and providing a more true measurement of the ink zetapotential. This again is evidence of the excellent dispensability of the silver nanoparticles within the ink medium and a concentration of 10% and less the critical −20 mV value is reached confirming the stable nature of these inks.

TABLE 7
Zeta Potential vs. Concentration

| Sample | Zeta Potential (mV) |
|---|---|
| S344A(Average) | −12.4 mV |
| S344A50% Conc | −17.2 mV |
| S34410% Conc | −20.0 mV |
| S3445% Conc | −20.9 mV |

The final zeta dependence study is that of its dependence on centrifugation of the ink, i.e. removing the polymer PVA ink medium. Table 8 shows the results of this analysis. All spins on the centrifuge were preformed at 19.1 k RCF at 4° C. after each spin the sample was suspended in 1 ml of deionised water. A is the ink before any centrifugation, B is the ink after a 50 minute spin and then resuspended in 1 ml Deionised water and the subsequent measurements are after further subsequent 20 minute spins.

TABLE 8
Zeta Potential dependence on Centrifugation

| | Sample 1 |
|---|---|
| | Zeta Potential (mV) |
| A | −1.45 |
| B | −9.27 |
| C | −16.1 |
| D | −16.7 |
| E | −18.7 |

A definite decrease/improvement in zeta potential with centrifugation is shown confirming that the shielding effect of the polymer is being removed. However it must be noted that the zeta potential never reaches the stability barrier of <−20 mV which indicates that the polymer is not being completely removed from the particles.

Overall from these zeta potential measurements we can see that the presence of the PVA in the nanoparticles creates a shielding effect and reduces the measurable zeta potential value.

### Example 14

### Ink Incorporating Silver Nanoplates with One Predominant Shape in an Aqueous Solution

It is desirable to have an ink comprising silver nanoplates of one predominant shape, such as the nanoplates produced in accordance with the methods of Example 8 above and/or nanoplates having the physical properties described in Example 9 above. In this particular example, we incorporated triangular silver nanoplates into an ink according to the following method:

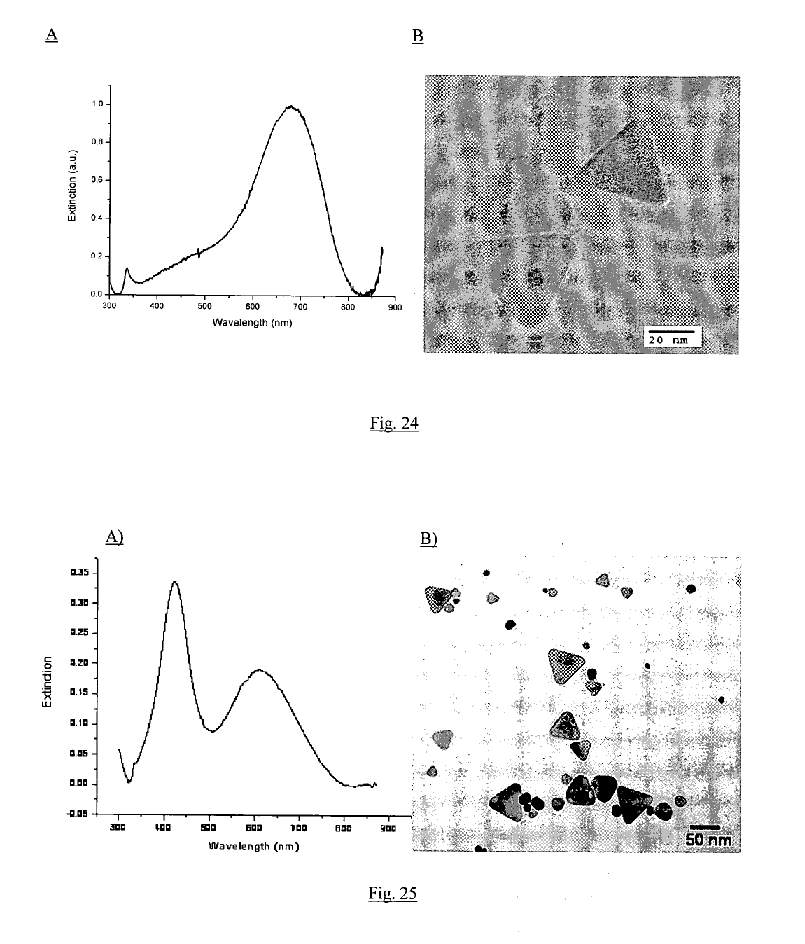

A solution comprising 0.5 ml of 2.5×10⁻² M of trisodium citrate, 0.3 ml of 0.01 M sodium borohydride, 0.25 ml of 500 mg/l poly(sodium 4-styrene sulfonate) of MW˜1,000,000 and 4.5 ml of deionised water was prepared and placed in a beaker with a magnetic stirrer, stirring rapidly. 3 ml of a 5×10⁻⁴ M silver nitrate solution was added with a peristaltic pump at a rate of 2 ml/min while the mixture is stirring. This mixture is referred to as the seed mixture. A 0.6 ml of 0.01 M ascorbic acid, 1 ml of the seed mixture and 50 ml of deionised water solution was prepared and placed in a beaker with a magnetic stirrer, stirring rapidly. 30 ml of a 5×10⁻⁴ silver nitrate solution was added at a rate of 10 ml/min with a peristaltic pump. The final solution was topped with 5 ml of a 2.5×10⁻² trisodium citrate solution and 15 ml of deionised water. Referring to FIG. 24, the ink comprised triangular silver nanoplates having a main peak at 676 nm.

### Example 15

### Ink Incorporating Silver Nanoplates with Two Dominant Shapes in an Aqueous Solution

In some circumstances it is desirable have an ink comprising silver nanoplates of two predominant shapes. The nanoplates may be produced in accordance with Example 8 above. Some of the nanoplates, may posses the physical properties described in Example 9 above. Aqueous solution inks were made using a batch chemistry and a microfluidics process as described below.

### Seed Stage:

A solution comprising 0.5 ml of 2.5×10⁻² M of trisodium citrate, 0.3 ml of 0.01 M sodium borohydride, 0.25 ml of 500 mg/l poly(sodium 4-styrene sulfonate) of MW˜1,000,000 and 4.5 ml of deionised water was prepared and placed in a beaker with a magnetic stirrer, stirring rapidly. 3 ml of a 5×10⁻⁴ M silver nitrate solution was added with a peristaltic pump at a rate of 2 ml/min while the mixture is stirring. This mixture is referred to as the seed mixture. The seed solution was aged for at least 2 h prior to use.

### Growth Stage:

A solution of Polyvinylalcohol (PVA) (1 wt %, 50 mL) and silver nitrate (AgNO₃) (10 mM, 1.25 mL) was heated to 40° C. and maintained at this temperature for 30 minutes in a water bath in the dark. The seed solution (500 μL) was then added with stirring followed by ascorbic acid (0.1 M, 250 μL).

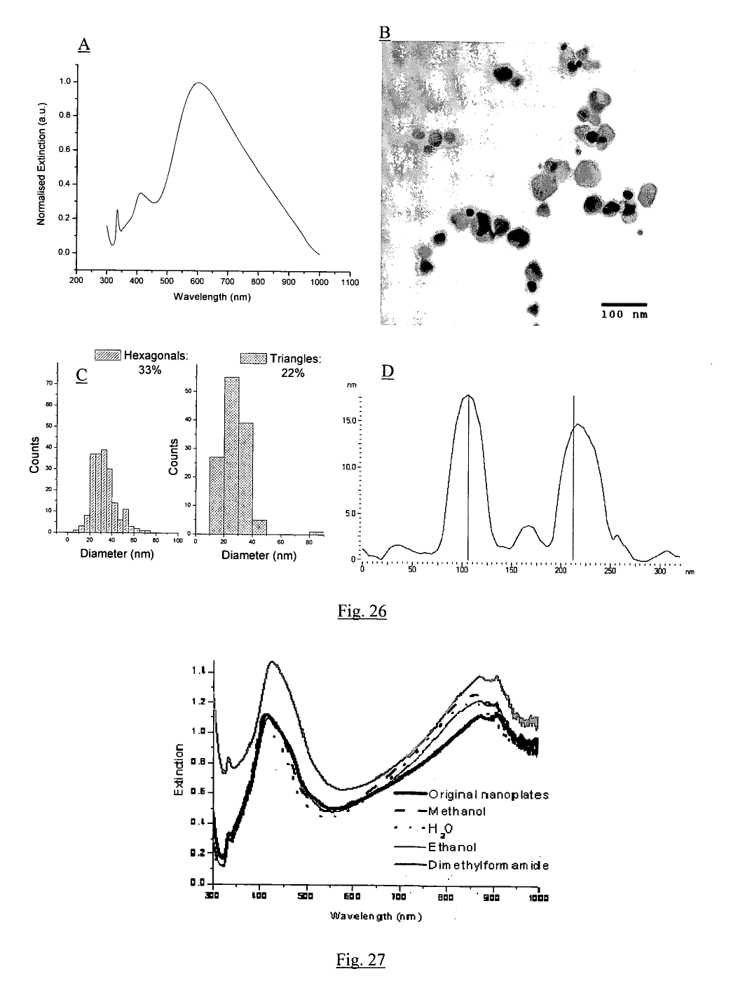

Referring to FIG. 25, the two dominant shapes in this case were nanoprisms and hexagonal nanoplates. It can be seen from the UV-VIS spectrum of FIG. 25A that the ink has two main peaks, one in the 425 nm region corresponding to the hexagonal nanoplates and one in the 600 nm region corresponding to the nanoprisms.

### Microfluidic Method

The seed solution was prepared using a microfluidic chip as described in Examples 1 to 3 above. In this particular Example the seeds were synthesised in the presence of poly(sodium 4-styrene sulfonate) of MW˜1,000,000 at a concentration of 10⁻⁴ M.

AgNO₃ (5 mg) and TSC (7.4 mg) were dissolved in 100 mL H₂O which is referred to as solution A. A NaBH₄ (10 mM) solution was prepared in water referred to as solution B. Solution A and solution B were pumped into a microfluidic chip at flow rates of 8 ml min⁻¹ and of 1 ml min⁻¹ respectively. A colour change form colourless to yellow was observed. The seed solution was aged for at least 2 h prior to use.

The growth stage was performed using the batch wet chemistry method as described above.

This method produced silver nanoparticles which consisted of about 50-70% shaped nanoplates. Referring to FIG. 26 the two dominant shapes were hexagonal plates and nanoprisms. AFM measurements show mean heights to be in the range of 12-20 nm for silver nanoplates in the ink.

### Example 16

### Ink Incorporating Silver Nanoplates with Two Dominant Shapes in an Organic Solution

In this example, inks comprising nanoplates of two dominant shapes in an organic solvent were produced according to the following method.

### Seed Stage:

AgNO₃ (5 mg) and TSC (7.4 mg) were dissolved in 100 mL Millipore water. 20 mL of this solution was placed in a 50 mL beaker, in an ice-bath. NaBH₄ (600 μL, 0.01 M) was added drop-wise by hand using a micropipette. The seeds were then aged for 3 hours before use in the next step.

### Growth Stage:

Polyvinyl pyrrolidone (PVP) (1 wt %, 10 mL, MW=10,000 or 29,000 or 55,000), seed solution (100 μL), ascorbic acid (50 μL, 0.1 M) and TSC (300 μL, 2.5×10⁻² M) were placed in a 50 mL beaker and stirred together for 3 minutes. AgNO₃ (5×50 μL, 0.01 M) was added in aliquot with 30 seconds between each addition. The sol was aged for 2 h before being centrifuged at 13,200 rpm for 30 minutes and the pellets were redispersed in a variety of solvents namely methanol, ethanol and dimethylformamide.

It will be appreciated that when nanoplates are dispersed in an organic solvent to form an ink that an appropriate polymer i.e. a polymer that is soluble in a organic solvent is used in the growth step. In this case, PVP was used.

The silver nanoplates produced from the procedure described above, with PVP as the polymer of choice, were redispersed in one non-organic (water) and various organic solvents (methanol, ethanol and dimethylformamide). FIG. 27 shows the UV-Vis absorption spectra of the original nanoplates and the nanoplates redispersed in methanol, water, ethanol and dimethlyformamide. Each spectrum displays three wavelength maxima in the 345 nm, 420 nm and 870 nm regions. This indicates that not only have the redispersed nanoplates kept their number of predominant shapes and their sizes, but also that quite of a good range of organic solvents is available to redisperse the silver nanoplates to produce a non-aqueous ink without damaging the silver nanoplates in any way.

### Example 17

### Concentrating the Nanoplates

In some circumstances it is desired to have an ink comprising a high loading concentration of silver nanoplates. It is possible to concentrate the nanoplates after completion of chemical reduction, stabilisation and if necessary functionalisation of the nanoplates. In this particular example, the nanoplates were concentrated by centrifugation in a Sorvall RC 5C Plus centrifuge with a SLA 3000 rotor at 12,000 rpm (24,318 rcf) for 4 hours for a first pass and in an Eppendorf 5415R centrifuge with a F-45-24-11 rotor at 13,200 rpm (16,100 rcf) for 1 hour for a second pass. The initial concentration and volume before centrifugation were, for example, 70 ppm in 1,800 ml respectively. After the first pass, the supernatant volume collected was 1,680 ml giving an ink concentration and volume of 1,050 ppm and 120 ml (concentration factor: 15×). After the second pass, the supernatant volume collected was 112 ml leaving a final ink with a concentration of 15,750 ppm and a volume of 8 ml (concentration factor: 15×).

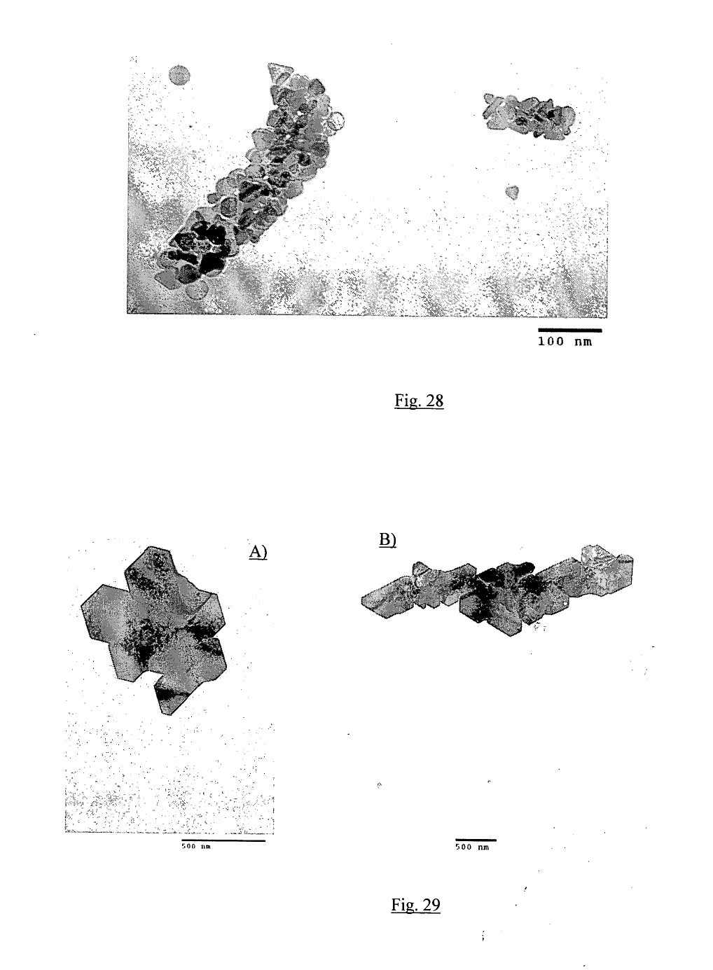

FIG. 28 is a TEM image of the concentrated ink after the second pass.

The following equation: concentration_{Ag} (wt %)=concentration_{Ag} (ppm)×100/density_{water} (mg/l) is used to convert the concentration value in ppm. The final concentration of the silver nanoplate produced in this example is therefore around 1.5 wt %. This value is more than an order of magnitude less than values of concentration of silver nanoparticle inks available in the market, such as Advanced Nano Products inks, which have concentrations in the region of 50 wt %. However as shown in Example 21 below, the resistivity values of the silver nanoplate ink containing 1.5 wt % silver perform very well for such low silver content inks. This is surprising and highly advantageous as the inks described herein have equal or superior conductivity values, i.e. equal or lower resistivity values compared to commercially available inks.

### Example 18

### Rheology of Silver Nanoplate Ink as Prepared by Example 15 Above (Microfluidic Production of Seeds and Batch Growth)

Viscosity and surface tension are the two most important properties of general inks. In order to achieve rheology conditions (viscosity and surface tension) which are appropriate for inkjet printing, additives such as polymers (e.g. polyvinyl alcohol (PVA), polyvinyl pyrrolidone (PVP)) and cosolvent to water (e.g. diethylene glycol (DEG)) were incorporated in to the silver nanoplate ink.

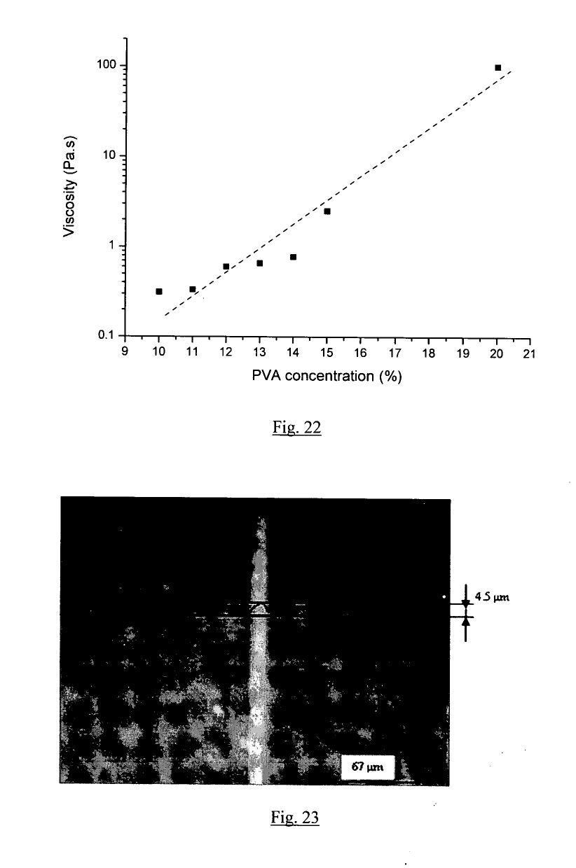

Various concentration of PVA from 10 to 20% wt were added to silver nanoplate inks. Viscosity tests were performed using an AR-500 TA Instruments Rheometer for the series of PVA-based solutions. A Carreau model was used to fit the data from the rheometer and extract the nanosilver ink's viscosity values. FIG. 22 shows the viscosity of PVA-based nanosilver inks as a function of PVA concentration. An exponential fit to the data is used to determine the appropriate PVA concentrations: log(viscosity)=−3.35+0.26×concentration. Based on the viscosity value suitable for inkjet printing of 10 mPa·s, it can be extrapolated from these results that our preferred PVA concentration is in the region of 5% wt.

In order to lower the surface tension of the silver nanoplate ink at a temperature of 20° C. close to the 30 dyn.cm⁻¹ region (water has a surface tension of 72 dyn.cm⁻¹ at 20° C.), diethylene glycol was used as a cosolvent to water. A polyvinyl pyrrolidone stabilised silver nanoplate solution was prepared and centrifuged as described in example 17 above. The recovered and concentrated silver nanoplate ink was dispersed by diethylene glycol (DEG) as a cosolvent to water to various concentrations in an ultrasonic bath to form the ink for testing. The preferred DEG to water weight ratio was found to be around 50 wt %.

### Example 19

### Functionalisation of Silver Nanoplates

The silver nanoplates may be functionalised or treated with chemical or biochemical agents, such as cytidine 5′-diphosphocholine, mercapto-hexanoic acid or mercapto-benzoic acid, to promote the formation of conductive paths. In this example we investigate the formation of conductive paths on TEM grids.

Triangular silver nanoplates (TSNP) were produced by the two-step seed mediated method as described in Example 14 above. Post synthetic stabilization of the as prepared triangular silver nanoplates was carried out in a versatile manner which allows the surface chemistry of the nanoplates to be altered depending on their intended use.

Triangular silver nanoprisms were functionalised with phosphochlorine as follows: 1 mL of a 30 mM freshly prepared aqueous solution of cytidine 5′-diphosphocholine (PC) was added to the triangular silver nanoplates prepared as described above. After an initial 30 minute incubation period, 500 μL of 25 mM trisodium citrate (TSC) was then added to sol for increased stabilization. The total volume of the sol is then brought to 10 mL with distilled water and the sol was left undisturbed at 4° C. in the dark for over night incubation.

TEM grids were prepared as follows:

1 mL of the PC functionalised nanoplates were centrifuged at 13,200 rpm at 4° C. for 30 minutes. The colourless supernatant was carefully removed and the pellet was resuspended in 100 μL distilled H₂O. 20 μL of this concentrated sol is then dropped onto a Formvar coated copper TEM grid. The excess liquid was allowed to evaporate overnight The grid was then placed in a storage box until TEM analysis was carried out. During the overnight drying process, the solvent is removed by evaporation. The TSNP are forced into closer contact as the volume of the solvent is reduced. When the TSNP come into closer contact, there is a need to reduce the total surface energy of the plates and a morphological reconstruction takes places that minimizes the number of higher energy crystal planes. This process could involve fragmentation of the TSNP or fusing together of the TSNP. More than likely, it involves a hybrid of these two processes. As a result from the TEM images of the PC treated silver nanoplates (FIG. 29) the nanoplates appear to have agglomerated.

### Example 20

### Ink-Jet Printing of Silver Nanoplate Inks

Silver nanoplate inks at concentrations of the order of 1×10⁴ ppm were ink jet printed on to a glass substrate using a MicroFab's JetLab II® Polymer/Solder/Ink Jetting System. Jetting parameters such as pulse frequency and pulse shape (rise, fall, dwell times) were investigated to obtain suitable drop velocities and sizes. Printing parameters such as droplet fall delays in combination with xy-stage movement were optimised to achieve smooth conductive tracks with high resolution.

Parameters used included:

| | | |
|---|---|---|
| Offset (x, y) mm | 0 | 0 |
| DC level (V) | 0 | |
| Rise (μs) | 1 | |
| Dwell (μs/V) | 20 | 27 |
| Fall (μs) | 1 | |
| Echo Dwell (μs/V) | 5 | −15 |
| Final Rise (μs) | 1 | |
| Frequency (Hz) | 550 | |
| Idle Wave | Off | |
| Back Pressure = | −0.3 kPa | |

Strobe Delay set to 100 μs

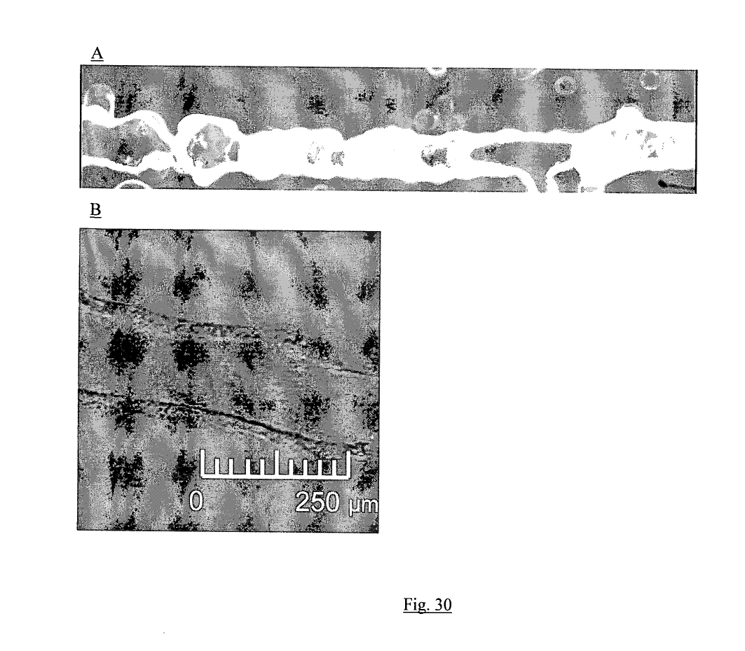

Referring to FIG. 30, the ink-jet printed line had a line width of approximately 150 μm and thickness of 96 nm before and after annealing at 200° C. for 6 minutes. The resolution achieved was of the order of 10,000 dots per square inch (DPI).

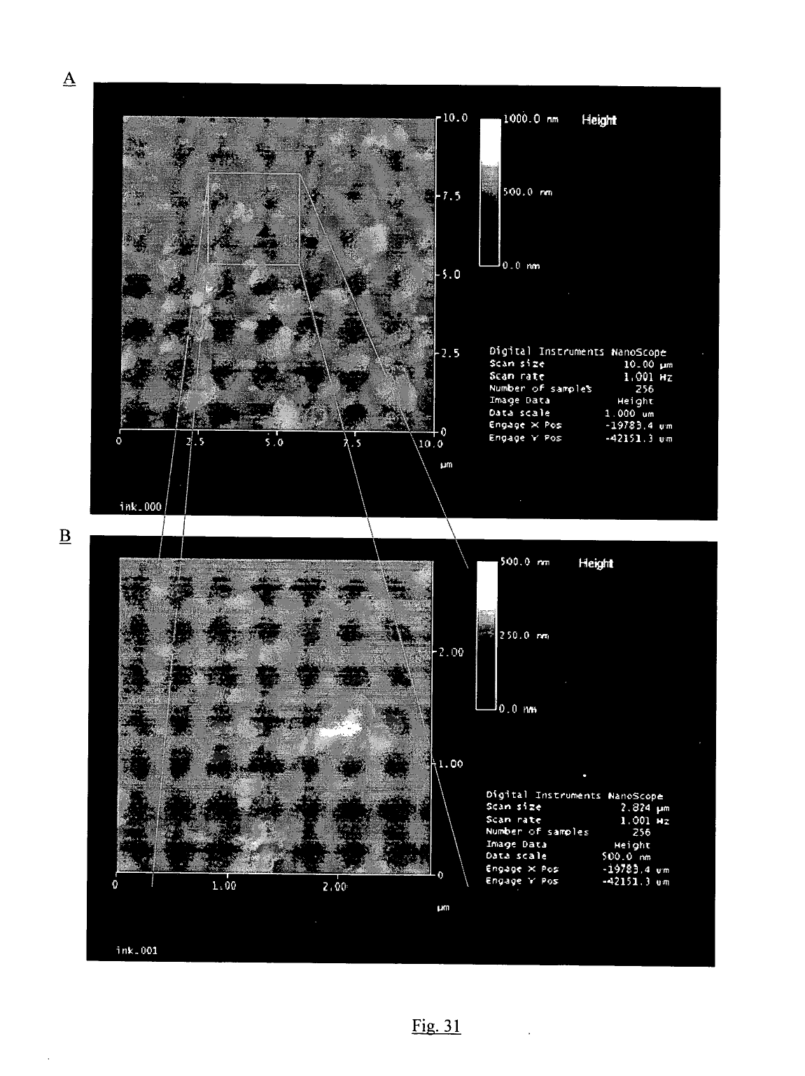

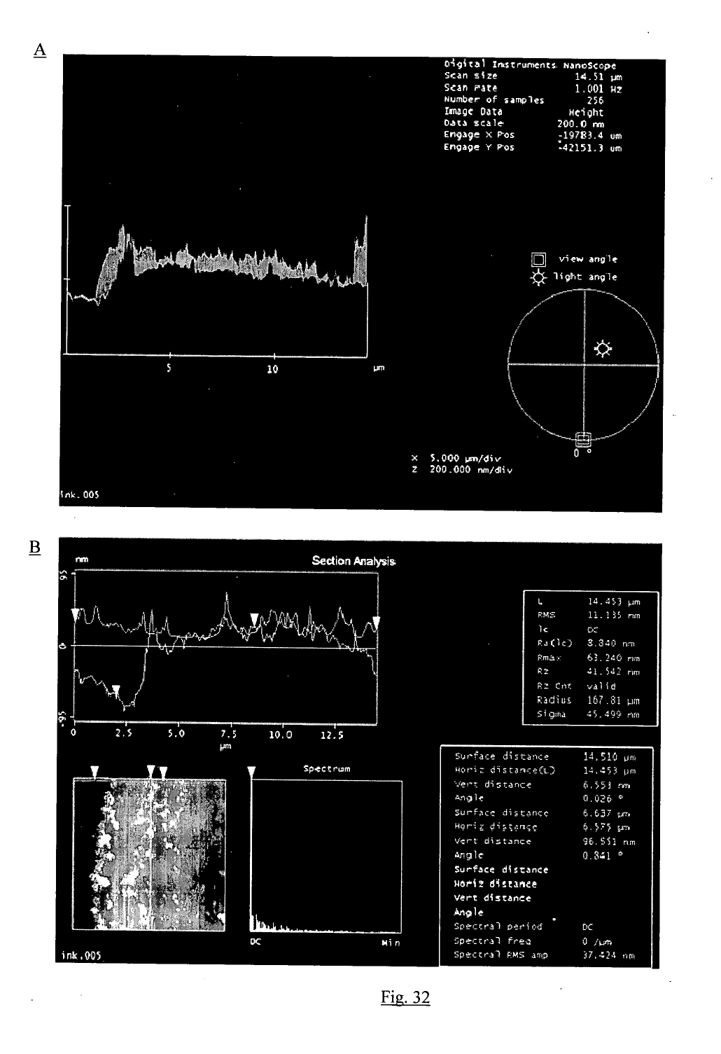

The thickness of the silver nanoplate ink jet printed line was estimated using an Atomic Force Microscope (AFM) used in tapping mode. FIG. 31 shows AFM top view images of the silver nanoplate ink printed line and features of the order of a couple of micrometers in size and around 500 nm in height can be seen. FIG. 32 shows the cross section analysis of the edge of the silver nanoplate ink jet printed on a glass substrate and the thickness of the printed line can be estimated to be around 96 nm from this analysis.

This is of significance because it demonstrates that ultrafine ink jet printed conductive tracks can be manufactured using the high aspect ratio silver nanoplate inks which allows for less material (ink) to be used whilst providing for equal or superior electrical properties. In other words, equal or superior conductivities can be achieved at lower metal content when a contact is achieved with such an ultrafine conductive path. Furthermore, semi-transparent conductive tracks, which can have applications in fields such as photovoltaics, can be manufactured using the silver nanoplate ink at such low thicknesses.

### Example 21

### Resistivity of Nanoplate Inks

Increased percentage of shaped nanoplates at high aspect ratios over spherical nanoparticles provides increased surface contact area from the greater packing as indicated in FIG. 33 thereby providing improved conductive paths and conductivity of the printed inks, i.e. lowering the resistivity of the printed inks. This can in turn lead to lower percolation thresholds for shaped nanoplate based inks over spherical nanoparticle inks.

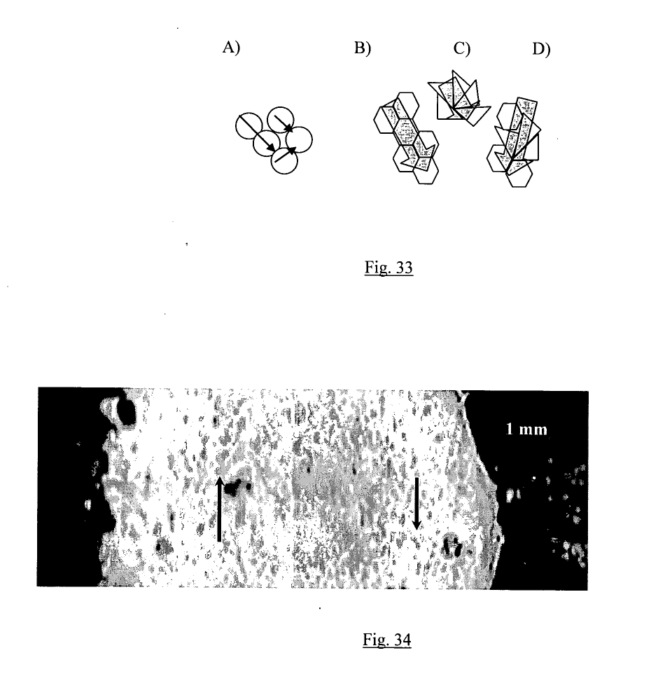

A 1 wt % concentrated silver nanoplate ink was printed on a DK test chip with gold metallisation and silicon nitride passivation, bridging some conductor lines as seen in FIG. 34. The printed ink was annealed at 200° C. for 6 minutes.

A 2-point probe resistance measurement of the annealed ink-jet printed silver nanoplate ink was performed to estimate its resistance. The procedure used was a standard IV measurement, regularly calibrated with a short and an open value to negate the resistance of the probes. One of the probe tips was at ground and connected to one end of the printed line and the other was connected to the other end of the printed line and had a voltage being swept from 0-10V in 0.01V steps using a Keithley 2400 sourcemeter. To calculate resistance, the current can be plotted on a y-axis and the voltage on the x-axis. The slope of the line will give the resistance value. The average resistance (R) value for this example was 958Ω. This value could vary as a result of contact resistance. In order to estimate the silver nanoplate ink's resistivity (ρ), a few geometrical parameters have to be taken account, namely the distance between the two probe contacts (L), their thickness (l) and the printed ink's thickness (t), as the following equation shows: ρ=R×t×l/L. In this example, it is estimated that L=400 μm, 1=10 μm and t=100 nm and, therefore, that the 1 wt % silver nanoplate ink exhibits a resistivity in the region of 2.5×10⁻⁴ Ω.cm.

As a reference, bulk silver resistivity is in the region of 1.6×10⁻⁶ Ω.cm. The silver nanoplate ink prepared in this example exhibits a resistivity, which is two orders of magnitude higher than that of bulk silver. However the silver content present in the silver nanoplate ink is two orders of magnitude lower than that of bulk silver. Furthermore, Table 9 below shows that this resistivity result is an order of magnitude higher than samples 1 & 2 presented in this Table but the concentration of the silver nanoplate inks used in the example is more that an order of magnitude lower. These results suggests that the ultrafine silver nanoplate ink described herein displays equal or superior conductivity, i.e. equal or lower resistivity properties at a low silver content level compared with commercially available silver conductive inks, where typically 70% wt of silver loadings are used.

TABLE 9
examples of other ink jet printed silver inks with their relative particle size (nm), solvent
choice, concentration (wt %), curing condition (° C.), line width (μm), line thickness (nm) and
resistivity (Ω · cm).

| | Particle | | | Curing | Line | Line | | |
|---|---|---|---|---|---|---|---|---|
| | size | | Concentration | condition | width | thickness | Resistivity | |
| | (nm) | Solvent | (wt %) | (° C.) | (μm) | (nm) | (Ω · cm) | Reference |
| 1 | 1-10 | Toluene | 30-35 | 300 | 120 | 1000 | 3.5 × 10⁻⁵ | Szczech J. B., |
| | | | | | | | | Megaridis C. M., |
| | | | | | | | | Gamota D. R., |
| | | | | | | | | Zhang J., |
| | | | | | | | | IEEE Trans. |
| | | | | | | | | Electron. |
| | | | | | | | | Packaging |
| | | | | | | | | Manufact. 25, |
| | | | | | | | | 26 (2002) |
| 2 | 10-50 | Water- | 25 | 150-260 | 130 | 532 | 1.6 × 10⁻⁵ | Hsien-Hsueh L., |
| | | DEG | | | | | | Kan-Sen C., |
| | | | | | | | | Kuo-Cheng H., |
| | | | | | | | | Nanotechnology |
| | | | | | | | | 16, 2436 (2005) |

### Example 22

### Use of Inks Comprising Silver Nanoplates in Photovoltaics

First generation solar cells are typically made using a silicon (Si) wafer and are the dominant technology in the commercial production of solar cells, accounting for more than 86% of the solar cell market, due to the omnipresence of silicon as semiconductor in electronics. In the case of current generation inorganic photovoltaic silicon may soon find the limit of its efficiency (30%). Attempts to improve the electrical efficiency using thin-film Si cells, so-called second generation devices, instead of wafer-thick have to date proven even poorer.

Silicon is a poor light absorber which is a strong limiting factor on solar cell efficiency. Enhancement of the absorption of sunlight using surface plasmon resonance has been demonstrated (e.g. K. R. Catchpole, S. Pillai and K. L. Lin, “Novel Applications for Surface Plasmons in Photovoltaics”, 3^{rd} World Conference on Photovoltaic Energy Conversion—SIP-A7-09, 2714, 2003) wherein silver nanoparticles surface plasmons were used to enhance light trapping. Using 1.25-micron-thick thin-film incorporating the silver nanoparticles cells, the enhancement was by a factor of 16 for light with a wavelength of 1050 nm, while when using wafers, the enhancement was by a factor of 7 for light with a wavelength of 1200 nm. To date only low quality silver nanoparticles and silver islands have been used for this purpose.

Third generation organic photovoltaic devices are limited by there capability to absorb only a small portion of the incident light. A major reason for this is that the semiconductor bandgap is too high. A polymer with bandgap of 1.1 eV absorbs only 77% of the solar radiation on Earth. Semiconducting polymers have bandgaps higher than 2.0 eV, limiting the possible absorption to less than 30%.

The use of the highly geometrically uniform silver nanoplate inks described herein which are spectrally tunable throughout the relevant solar spectral range and also tunable to semiconducting polymers and Si band gaps will provide significant advantages for efficiency enhancement. A number of different silver nanoplate sizes with different peak wavelengths may be mixed to provide a broad spectral range as required. The benefits which the high definition silver nanoplates, can impart on photovoltaic devices include tunability of the silver nanoparticles to longer wavelengths from 550 nm to 1500 nm. They can also facilitate absorption, light trapping and guiding over a greater solar spectral range.

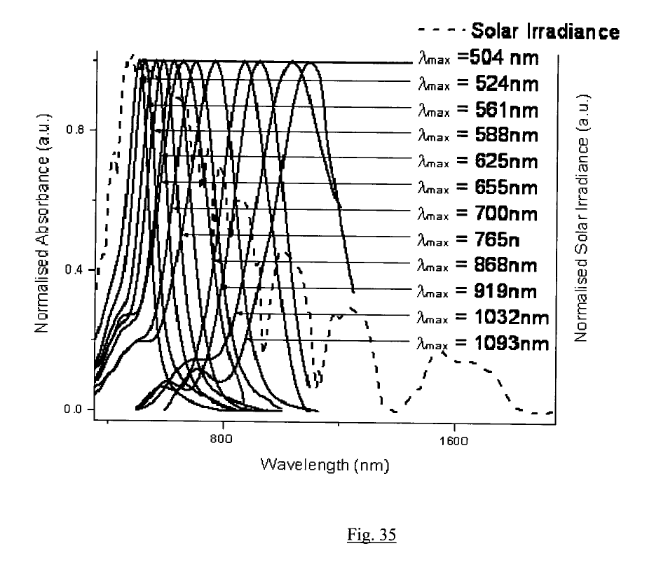

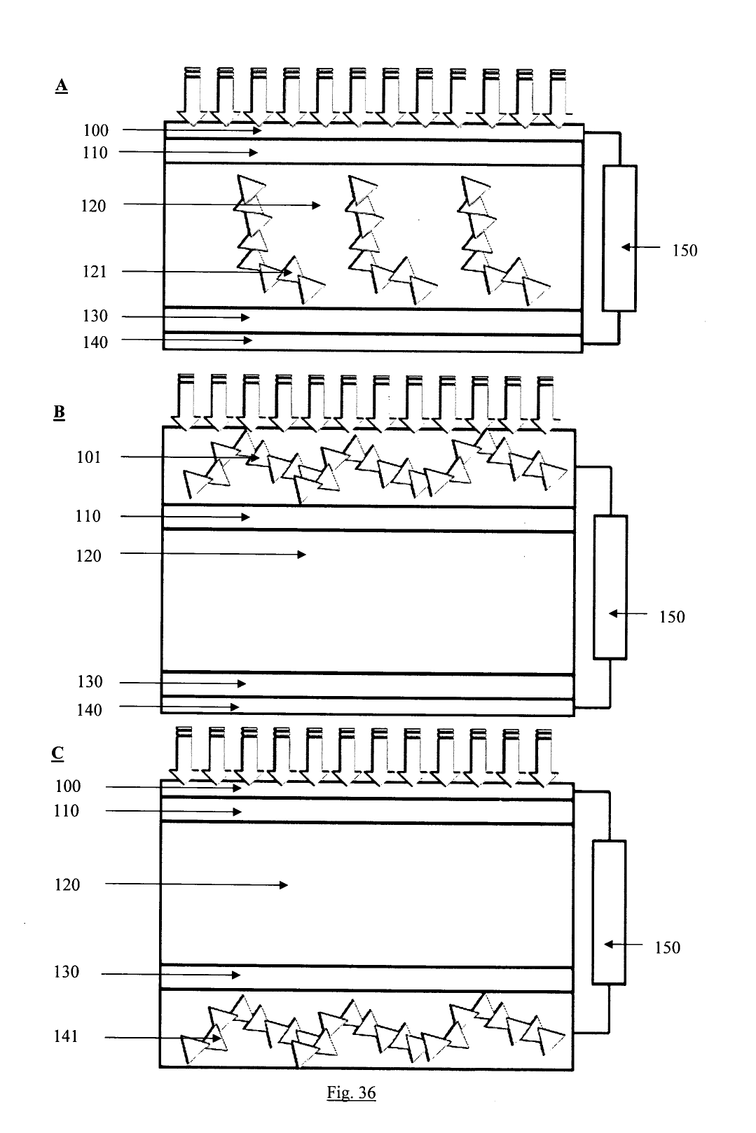

Optical tunability, i.e. varying the localised surface plasmon resonance (LSPR) positions of the silver nanoplates can be achieved by tuning the geometry and the edge length of the nanoplates. Ink solutions of silver nanoplates with different edge lengths and subsequent LSPR positions were investigated. A series of silver nanoplates with increasing edge length from 11 nm to 197 nm were prepared. The solution phase ensemble extinction spectra of the silver nanoplate solutions were acquired using a UV-Vis-NIR spectrometer with the peak LSPR resonances ranging from wavelengths of about 500 nm in the visible up to 1090 nm in the NIR. The spectra of a number of these samples as well as that of the solar spectral irradiance are shown in FIG. 35. It is clear that the inks described herein can be tuned across the relevant sun spectral range to allow for enhanced solar light trapping.

Further to the optical tunability of the silver nanoparticles, they may be directly incorporated into organic devices as polymer composites enabling more intimate interactions than in the case of current isolated layer deposition. In addition it is expected that the silver nanoparticles inherent conductive nature will contribute to the charge transport mechanisms of the photovoltaic devices thereby further improving device efficiency. The thinness of the active organic layer is also an efficiency limiting factor: the typically low charge carrier and exciton mobility's require layer thickness in the order of 100 nm. The very high scattering efficiency of the silver nanoplates will serve to increase the extinction coefficient of layers enabling increased efficiency at low thicknesses.

FIG. 36 (A) to (C) are schematics of photovoltaic devices incorporating silver nanoplate inks, where the active layer (120) can be and is not restricted to monocrystalline silicon (Si), polycrystalline Si, thin film Si, or organic materials (e.g. polythiophene derivatives and C₆₀ derivatives), where materials used for the semi-transparent top electrode (100) can be and are not restricted to titanium oxide or indium tin oxide, where the top intermediate layer (110) can incorporate hole blocking materials such as a metal oxide (e.g. zinc oxide) or a polyamine (e.g. polyethylenimine) and where the bottom intermediate layer (130) can incorporate electrically conductive materials such as metals (e.g. gold, silver, copper) or electrically conductive polymers (e.g. PEDOT). Top (100) and bottom (140) electrodes are in electrical connection with an external load (150) so that electrons pass from the top electrode, through the load and to the bottom electrode.

Referring to FIG. 36A colour tunable, highly sensitive (shaped and high aspect ratio) silver nanoplates (121) can be used as active materials incorporated within an active layer of organic materials. The silver nanoplates can be incorporated in for example a conductive polymer such as a fullerene derivative matrix and contribute either to the charge dissociation process involved, or the charge conduction mechanism or both, leading to increased efficiency.

Colour tunable, highly sensitive (shaped and high aspect ratio) silver nanoplates can be used as surface plasmon light trapping semi-transparent electrodes (101) as depicted in FIG. 36B. A series of silver nanoparticles with optical tunability across the whole solar spectral range can be used to harness every incoming photon's energy and in turn waveguide this energy into the active layer (120).

Colour tunable, highly sensitive (shaped and high aspect ratio) silver nanoplates can be used as efficiently conductive bottom electrodes (141) as depicted in FIG. 36C. The highly conductive nature coupled with the ultrafine feature of the silver nanoplate inks described herein can be used as to replace conventional conductive bottom electrodes, and contribute also to the conduction mechanism in the semi transparent top electrode (101) described in FIG. 36.

### Example 23

### Nanoplate Inks as Optical Filters

Optical tunability of silver nanoplate optical filter thin films across the visible and near-IR regions can be achieved by tuning the geometry and the edge length of the nanoplates used in the ink solutions.

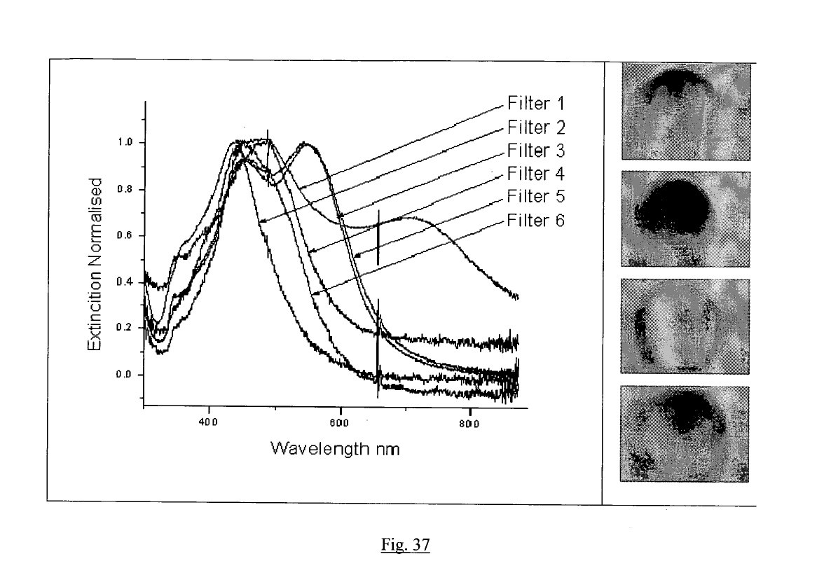

Ink solutions of silver nanoplates with different edge lengths and subsequent LSPR positions were prepared. Optical filter thin films were drop casted on glass substrates from shaped silver nanoplate ink solutions of various colours. UV-visible absorption spectroscopy and images of these optical filters, as seen in FIG. 37, shows how easily the filters colour can be tuned across the visible and near-IR regions using the ink described herein.

### Example 24

### Self Assembly of Nanostructures

A means of producing size and shape controlled nanoparticles and controlling their subsequent organisation into superstructures amenable to practical applications, are two of the primary goals of nanotechnology, the assembly of nanoparticles into well defined structures and architectures remains a challenges.

Self assembly of discretely shaped silver nanoparticles into a range of structured arrays and dendritic patterns.

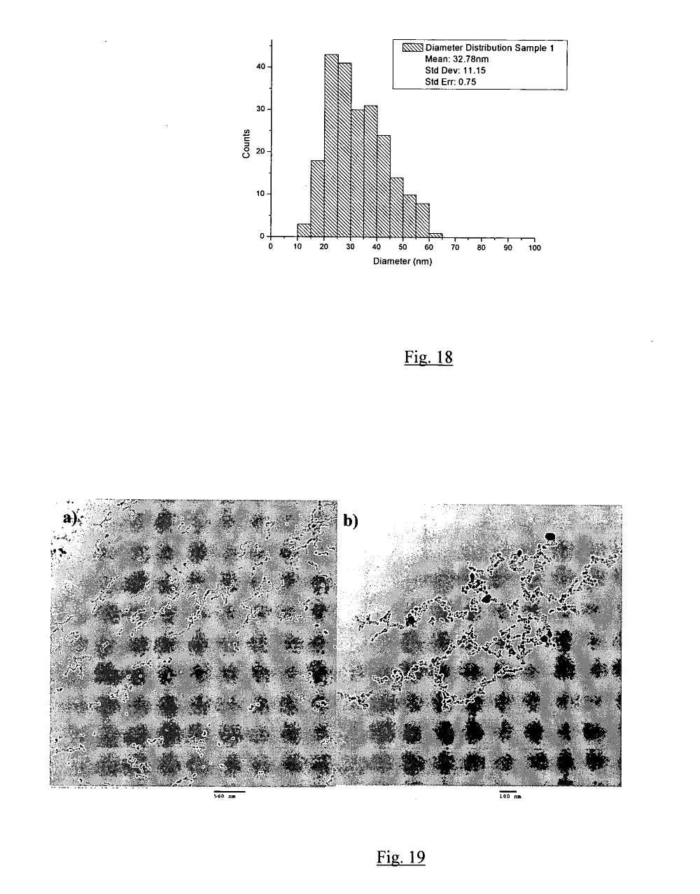

Branched linear arrays and linear chains with nanoscale diameters and lengths ranging up to tens of microns are among the structures that can be generated. Examples are shown in FIG. 19.

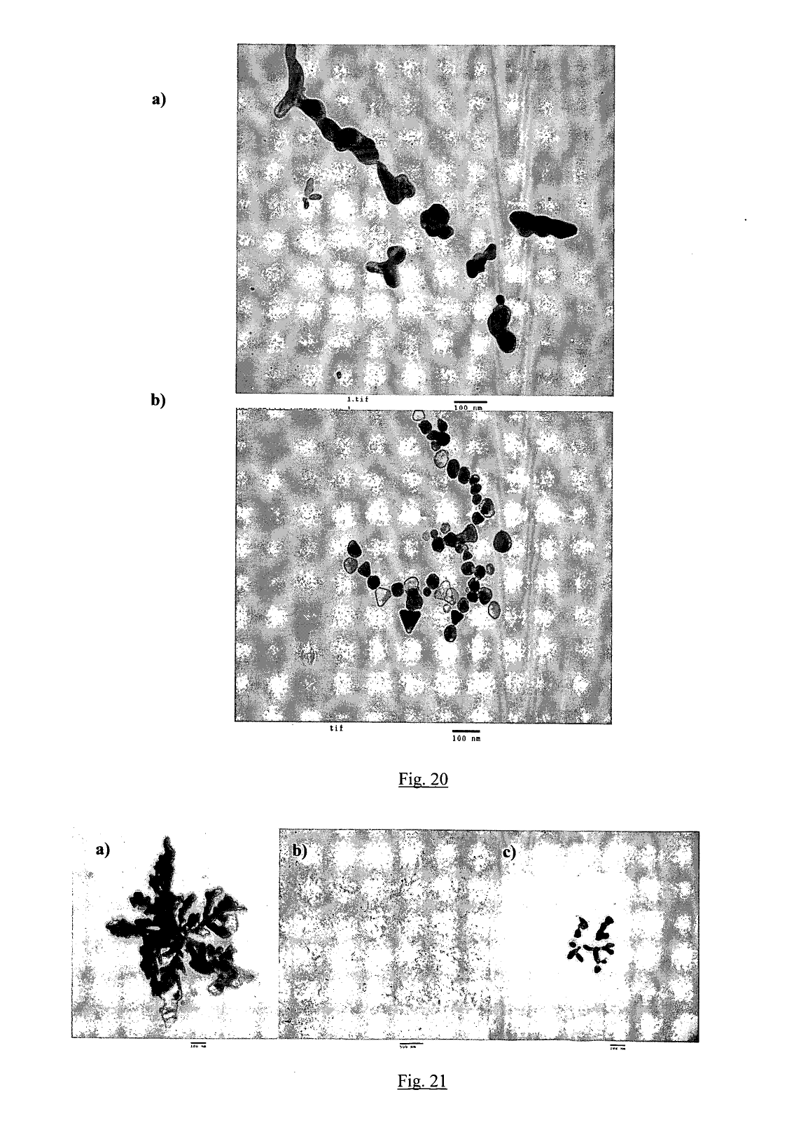

FIG. 20 shows the formation of a conductive track structure from the ink by two processes: (a) by the merging of nanoparticles (b) by the assembly of nanoparticles. The features displayed are commonly observed and include extended chains, hexagonal ordered branching and an extensive degree of linearity. These assemblies have large aspect ratios with lengths up to 50 μm and diameters as low as 20 nm.

Fern-like formations with fractal geometry and capsules with villi projected surfaces as well as fishbone structures are examples of the dendritic patterns produced, spanning the micron to the millimetre scale. Examples are shown in FIG. 21.

It should be noted also that nanoparticle shape, in particular nanoparticle of anistropic shape as is the case of the silver nanoparticles used here, have been reported to facilitate in control the geometry of self-assembled arrays [reference B. A Korgel, D. Fitzmaurice, Adv. Mat. 10 (1998) 661].

Given the major challenge is assembling and positioning nanoparticles in desired locations to construct complex high-order functional structures these examples disclose facile positioning of nanoparticles for lithography free patterning

### Preparation of Structured Linear Arrays

In a typical procedure inks comprising said silver nanoparticles and polyvinyl alcohol were drop-cast onto substrates including TEM grids, gold plated glass slides and silicon wafers and left to dry at room temperature. Imaging was carried out using both TEM and optical microscopes.

The silver nanoparticle inks spontaneously form of a range of exquisite dendritic patterns having fractal geometry on evaporation of the ink medium. The images in FIG. 21 illustrate a 2-D fern-like dendritic pattern with regular curved branching. The dimensions of the dendrites produced range from tens of nanometers to several millimetres, clearly demonstrating the fractal nature of the patterns. Microwave radiation may be used to promote growth producing dendritic patterns of even larger dimensions.

The nanoparticles can be aligned along the network:
Specific angles repeated
e.g. round nanoparticles in supernatant @ 14Krpm, & larger nanoparticles remaining.

Conventional pigments in ink-jet inks contain particles in the size range of 100-400 nm. In general, reducing the particle size to 50 nm or less should show improved image quality and improved printhead reliability when compared to inks containing significantly larger particles.

### Deposition of the Ink on a Substrate or Material

The ink may be deposited on a substrate or material using one or more methods which may be selected from: ink jet printing; spin coating, screen printing, drop coating. The deposition process conditions may be optimised to produce narrow line width conductive paths or structures, or optical films or coatings, or semi-transparent conductive films or coatings. The ink may find applications in the formation of electrodes, or optics, or flat panel display devices, or optical filters, or active or passive layers on photovoltaic or solar cells, or active or passive layers in other electronic or opto-electronic devices.

The ink is of particular advantage in ink jet printing processes, because an ink jet process inherently does not allow the use of high-viscosity paste, and it is necessary to use a low-viscosity conductive ink including nanometer-scaled fine particles in such a process.

In one example, the ink, to which in some preferred embodiments of the invention may be added a dispersant and/or other chemical or biological additives, is expelled from an ink jet nozzle to print a pattern. Optionally, heat treatment may be carried out to remove the solvent and, where present, the dispersant and in some embodiments may promote to assembly and/or binding of the remaining metal particles to each other.

A conductive path, wire, line or structure formed using the ink, for example as described above, or otherwise formed, will typically show sharply increased conductivity as the metal solid content in the ink increases above the percolation threshold, and also as the thickness of a printed metal line increases.

The silver nanoparticles exhibit properties related to shape, and size, including those related to the ratio of surface area to volume, which are different from larger, micron sized metals, enabling these shape and size controlled silver nanoparticle based inks to work where other more traditional inks have failed.

The ink may find application in high volume production of electronic circuitry.

### Nanosilver Inks Viscosity

Viscosity tests were performed using an AR-500 TA Instruments Rheometer for a series of these ink formulations in polyvinyl alcohol (PVA) based solutions. A Carreau model was used to fit the data from the rheometer and extract the nanosilver ink's viscosity values. FIG. 22 shows that the viscosity of the PVA-based silver nanoparticle inks can be controllably varied as a function of PVA concentration. An exponential fit to the data (dashed line) is used as a guide to the eye. This characteristic of the ink is of importance in industrial applications in deposition methods including spin-coating, ink-jet printing, screen printing.

### Nanosilver Thin Films

A series of electrically conducting nanosilver thin films were produced by spin coating the nanosilver solutions on stainless steel substrates using a Chemat Technology spin coater. FIG. 23 shows a typical nanosilver thin film using a 15% PVA-based solution and a 2,000 rpm spin speed. A channel was made using a razor blade in order to estimate the thickness of the thin film with the help of the profile feature of the imaging software. A 4.5 μm thick film was produced using the above mentioned parameters.

The invention is not limited to the embodiment hereinbefore described, with reference to the accompanying drawings, which may be varied in construction and detail.

### REFERENCES

B. A Korgel, D. Fitzmaurice, Adv. Mat. 10 (1998) 661.
Hsien-Hsuch L., Kan-Sen C., Kuo-Cheng H., Nanotechnology 16, 2436 (2005)
J. Wagner, and J. M. Köhler. Continuous Synthesis of Gold Nanoparticles in a Microreactor NANO LETTERS Vol. 5, No. 4 685-691 (2005)
J. Michael Köhler, Marie Held, Uwe Hübner, Jörg Wagner. Formation of Au/Ag Nanoparticles in a Two Step Micro Flow-Through Process. Chem. Eng. Technol. 30, No. 3, 347-354 (2007)
J. M. Köhler, J. Wagner and J. Albert. Formation of isolated and clustered Au nanoparticles in the presence of polyelectrolyte molecules using a flow-through Si chip reactor. J. Mater. Chem. 15, 1924-1930 (2005)
J. Wagner, T. Kirner, G. Mayer, J. Albert, J. M. Köhler. Generation of metal nanoparticles in a microchannel reactor. Chemical Engineering Journal 101 251-260 (2004)
Johann Boleininger, Andreas Kurz, Valerie Reuss and Carsten Sönnichsen. Microfluidic continuous flow synthesis of rod-shaped gold and silver nanocrystals. Phys. Chem. Chem. Phys. 8, 3824-3827 (2006).
K. R. Catchpole, S. Pillai and K. L. Lin, “Novel Applications for Surface Plasmons in Photovoltaics”, 3^{rd} World Conference on Photovoltaic Energy Conversion—SIP-A7-09, 2714, 2003.
Szczech J. B., Megaridis C. M., Gamota D. R., Zhang J., IEEE Trans. Electron. Packaging Manufact. 25, 26 (2002)

1-44. (canceled)

45. An ink comprising a solution or suspension or mixture of silver nanoplates in a liquid wherein said nanoplates have a distribution of geometric shapes within which one shape geometries selected from the following is predominant:
circular plate shaped;
elliptical plate shaped;
triangular plate shaped;
hexagonal plate shaped;
other flat polygonal plate shaped.

46. The ink as claimed in claim 44 wherein predominant shape geometry is triangular plate shaped.

47. The ink as claimed in claim 44 wherein the nanoplate has an aspect ratio between 2 to 25

48. The ink as claimed in claim 44 wherein the liquid is an aqueous solution, the aqueous solution may be water.

49. The ink as claimed in claims 44 wherein the liquid is an organic solvent, the organic solvent may be an alcohol, such as ethanol or methanol, the organic solvent may be dimethylformamide.

50. The ink as claimed in claim 44 wherein the liquid is capable of being readily evaporated from a substrate on which the ink is deposited.

51. The ink as claimed in claim 44 wherein the ink comprises a viscosity lowering agent, the viscosity lowering agent may be a polymer, such as polyvinyl alcohol or polyvinyl pyrrolidone, the ink may comprise up to 20% wt of the viscosity lowering agent, the ink may comprise up to 10% wt of the viscosity lowering agent, the ink may comprise about 5% wt of the viscosity lowering agent.

52. The ink as claimed in claim 44 wherein the ink comprises a surface tension lowering agent, the surface tension lowering agent may be diethylene glycol, the ink may comprise up to 50% wt of the surface tension lowering agent.

53. The ink as claimed in claim 44 wherein the nanoplates are surface functionalised.

54. The ink as claimed in claim 53 wherein the nanoplates are surface functionalised with a chemical and/or a biological functionalising agent.

55. The ink as claimed in claim 54 wherein the functionalising agent is selected from one or more of: cytidine 5′-diphosphocholine, mercapto-hexanoic acid, and mecapto-benzoic acid.

56. The ink as claimed in claim 44 wherein the ink comprises a stabilising agent, the stabilising agent may be trisodium citrate.

57. The ink as claimed in claim 44 wherein the ink has an average resistivity value of up to 2.5×10⁻⁴ Ωcm.

58. The ink as claimed in claim 44 wherein the ink comprises up to 1.5% wt silver, the ink may comprise up to 30% wt silver, the ink may comprise up to 70% wt silver.

59. The substrate having an ink as claimed in claim 44 delivered or deposited thereon.

60. The substrate as claimed in claim 59 wherein part or all of the liquid is removed after delivery of the ink onto the substrate.

61. The substrate as claimed in claim 59 wherein a conductive path is formed after the delivery of the ink onto the substrate, at least some of the nanoplates and the liquid may form the conductive path, some of the nanoplates may form the conductive path by making contact with each other.

62. The wires or conductive lines, or tracks made using an ink as claimed in claim 44.

63. The use of an ink as claimed in claim 44 in the fabrication or manufacture of one or more selected from the group comprising electrical circuits, photovoltaic cells for solar power or fuel cell applications, and an optical filter.

64. The use of an ink as claimed in claim 44 to induce or enhance a plasmonic response.
